(19) United States
(12) Patent Application Publication
(10) Pub. No.: US 2009/0293998 A1
(43) Pub. Date: Dec. 3, 2009

(54) Oil-Tempered Wire and Method of Producing the Same

(76) Inventors: Yoshiro Fujino, Hyogo (JP); Nozomu Kawabe, Hyogo (JP); Takayuki Shiwaku, Hyogo (JP); Norihito Yamao, Hyogo (JP); Teruyuki Murai, Hyogo (JP)

Correspondence Address: MCDERMOTT WILL & EMERY LLP, 600 13TH STREET, N.W., WASHINGTON, DC, 20005-3096, US

(21) Appl. No.: 11/990,028

(22) PCT Filed: Jul. 27, 2006
(86) PCT No.: PCT/JP2006/314907

§ 371 Date: Jun. 11, 2008

(30) Foreign Application Priority Data
Aug. 5, 2005 (JP) 2005-228859
Aug. 29, 2005 (JP) 2005-248468

(51) Int. Cl. C21D 9/52; C22C 38/34; B32B 15/04

(52) U.S. Cl. 148/596; 148/318

(57) ABSTRACT

An oil-tempered wire that has high fatigue strength and toughness after the nitriding treatment, and a method of producing the same, and a spring using the oil-tempered wire are provided. The oil-tempered wire has a tempered martensite structure. A lattice constant of a nitride layer formed on a surface of the wire is 2.870 Å to 2.890 Å when the oil-tempered wire is nitrided. The oil-tempered wire is produced by wire drawing a steel wire and quenching and tempering the wire drawn steel wire. The quenching is performed after the radiation heating is performed at 850 to 950° C. for over 30 sec to 150 sec, and the tempering is performed at 400 to 600° C.

### RELATED APPLICATIONS

This application is the U.S. National Phase under 35 U.S.C. § 371 of International Application No. PCT/JP2006/314907, filed on Jul. 27, 2006, which in turn claims the benefit of Japanese Application Nos. 2005-228859 and 2005-248468, filed on Aug. 5, 2005, and Aug. 29, 2005, respectively, the disclosures of which Applications are incorporated by reference herein.

### TECHNICAL FIELD

The present invention relates to an oil-tempered wire, a method of producing the oil-tempered wire, and a spring using the oil-tempered wire. More specifically, the present invention pertains to an oil-tempered wire that combines excellent fatigue strength and toughness when a steel wire is subjected to spring processing to perform nitriding treatment.

### BACKGROUND ART

Recently, size and weight reduction of engines or transmissions of vehicles have been made to cope with the low fuel efficiency of the vehicles. Accordingly, since strictness to stress that is applied to a valve spring or a transmission spring of the engine is increased, it is required that a material of the spring has improved fatigue strength, and that the material desirably combines fatigue strength and toughness. A silicon chromium-based oil-tempered wire is typically used as the material of the valve spring or the transmission spring of the engine.

Technology of the oil-tempered wire is disclosed in the Patent Documents 1 and 2.

The Patent Document 1 relates to a steel wire for a spring, and discloses an oil-tempered wire that is obtained by heating at a heating rate of 50 to 2000° C./s for 0.5 to 30 sec during quenching and tempering. In connection with this, the grain size of prior austenite is reduced, and the carbide configuration is converted into the fiber configuration in the grain. Thereby, since a function of reinforced fibers is provided to the carbide, fatigue endurance is improved.

Meanwhile, the Patent Document 2 relates to spring steel, and discloses an oil-tempered wire which has appropriate chemical components and a predetermined presence density of the cementite-based spherical carbide having a predetermined size. Thereby, the spring steel has high strength, and the carbide configuration of the spring steel is controlled during heat treatment after rolling, that is, coarsening of the cementite-based carbide is prevented, thus assuring coiling characteristics.

Furthermore, the Patent Document 3 relates to a steel wire for a spring, and discloses an oil-tempered wire that is subjected to quenching and tempering. In the oil-tempered wire, a ratio of 0.2% bearing force and tensile strength is set to 0.85% or less, thereby improving the coiling ability. Further, the Patent Document 3 discloses that, after the oil-tempered wire is heated at 420° C. for 20 min, 0.2% bearing force is increased by 300 MPa or more, thereby improving fatigue resistance.

Patent Document 1: JP 2002-194496 A

Patent Document 2: JP 2002-180196 A

Patent Document 3: JP 2004-315968 A

### DISCLOSURE OF THE INVENTION

### Problems to be Solved by the Invention

However, the inventions of the above-mentioned documents do not disclose an oil-tempered wire that has high fatigue strength and toughness when steel wire is subjected to spring processing to perform nitriding treatment. Currently, the demand for high fatigue endurance is growing, and the steel wire is subjected to spring processing and then nitrided during the production of a spring. Accordingly, it is important to improve elastic characteristics after the nitriding treatment.

First, as to the steel wire for the spring disclosed in the Patent Document 1, a heating keeping time and a heating rate are specified in the quenching and tempering processes to convert the carbide configuration into the fiber configuration, thereby improving the fatigue endurance. The carbide configuration shows a state of the steel wire after the quenching and the tempering, but does not show the state of the wire that is subjected to the spring processing and the nitriding treatment. In consideration of the elastic characteristics, a state of carbide after the nitriding treatment is important. The method of producing the steel wire is characterized in that the quenching and the tempering are performed for a short time. However, it is difficult to assure desirable toughness of the oil-tempered wire after the nitriding treatment, to reduce the size of carbide after the nitriding treatment, and to assure high fatigue strength and toughness. Particularly, in order to improve the fatigue endurance of the spring using the oil-tempered wire, it is necessary to improve toughness of the steel wire. Additionally, only control of the carbide configuration precipitated during the tempering process is insufficient to improve the fatigue endurance. Accordingly, it is necessary to sufficiently dissolve the insoluble carbides during the austenitizing. However, the Patent Document 1 does not disclose means for dissolving the insoluble carbides.

Meanwhile, as to the spring steel disclosed in the Patent Document 2, the method of producing the spring steel is characterized in that the composition of steel material is specified, and that strength and toughness are improved through heat treatment after rolling. However, in this technology, it is difficult to expect improvement in fatigue limit of the spring after nitriding treatment.

The technology of the Patent Document 3 does not disclose properties of the material after heat treatment corresponding to heating for a long time and nitriding treatment. In view of the recent trend of the long nitriding treatment of the spring (at 420 to 500° C. for 1 to 4 hours), the properties of the material after the heat treatment for a longer time are important. In addition, an important factor improving fatigue endurance is an absolute value of yield stress (0.2% bearing force). Since the Patent Document 3 does not disclose this, it is difficult to improve fatigue properties using the technology of the Patent Document 3.

The present invention has been made to overcome the above disadvantages occurring in the related art, and an object of the present invention is to provide an oil-tempered wire that has high fatigue strength and toughness after nitriding treatment, and a method of producing the same.

Further, another object of the present invention is to provide a spring that is obtained by spring processing of the oil-tempered wire and has high fatigue strength and toughness.

### Means for Solving the Problems

[Oil-Tempered Wire and Spring]

According to a first aspect of an oil-tempered wire of the invention, the oil-tempered wire has a tempered martensite structure. A lattice constant of a nitride layer formed on a surface of the wire is 2.870 Å to 2.890 Å when the oil-tempered wire is nitrided.

According to a second aspect of an oil-tempered wire of the invention, the oil-tempered wire has a tempered martensite structure. Yield stress after heating for 2 hours at 420° C. to 500° C. and yield stress after heating for 4 hours at the same temperature are higher than yield stress after heating for 1 hour at the same temperature.

According to a spring of the invention, the spring is formed by spring processing of an oil-tempered wire having a tempered martensite structure. A nitride layer is formed on a surface of the spring by the nitriding treatment, and a lattice constant of the nitride layer is 2.870 Å to 2.890 Å.

Hereinafter, an oil-tempered wire and a spring according to the invention will be described in detail.

<Nitriding Treatment>

As to the oil-tempered wire according to a first aspect of the invention, after quenching tempering, there are insignificant differences in terms of a lattice constant and the grain size of austenite in comparison with known materials. However, significant differences are confirmed in terms of the lattice constant of a nitride layer after the nitriding treatment and the size of carbide generated after the tempering process. The nitriding treatment is gas nitrocaburizing treatment, and is performed under the condition of 420° C. or more but 500° C. or less. This nitriding treatment condition corresponds to the condition of typical nitriding treatment performed after spring processing. In the nitriding treatment condition, a temperature is most important. If the temperature is high during the nitriding treatment, the lattice constant of the nitride layer as described later is increased. If the temperature is low, the lattice constant is reduced. A keeping time of the nitriding treatment is, for example, 2 to 4 hours. The gas nitrocaburizing treatment is typically performed in a mixed gas radiation heating of carburizing gas or nitrogen gas and NH₃ gas. Preferably, the amount of NH₃ gas added is, for example, 30 to 50%. This is the typical amount.

<Nitride Layer>

The nitride layer is a cured layer where carbonitrides are formed on a surface of the oil-tempered wire or the spring using the nitriding treatment. Typically, the nitride layer has the highest hardness at the surface of the wire (spring), and the hardness decreases as moving inward in the layer. The lattice constant as described later is obtained by X-ray diffraction. In connection with this, X-rays are radiated to a depth of 2 to 5 μm of the sample. Accordingly, the range of the nitride layer is set to the depth of substantially 5 μm from the surface of the wire (spring) in order to obtain the lattice constant as described later.

<Lattice Constant>

The lattice constant of the nitride layer is 2.870 Å to 2.890 Å. In case the steel wire is used as the material of the spring, the maximum shearing stress is applied to the surface of the wire. Accordingly, currently, the nitriding treatment is frequently performed after a coiling process in order to improve the surface hardness. Of alloy elements added to the steel wire, elements, such as Cr, V, and Mo, form nitrides between α-Fe lattices. Fatigue failure of the spring occur by local and concentrated slip deformation due to repeated external stress, causing unevenness at the surface of the spring. The nitrides formed between the lattices suppress the local slip deformation.

Furthermore, the nitrides formed between the lattices increase the lattice constant of α-Fe. The more the nitrides are formed between the lattices, the better the effect and the lattice constant are. The present inventors have been studied, resulting in the finding that when the lattice constant of the nitride layer is 2.870 Å, fatigue endurance is significantly improved. Accordingly, the lattice constant of α-Fe of the nitride layer of the oil-tempered wire (spring) after the nitriding treatment is set to 2.870 Å or more. However, if very many nitrides are formed, toughness is reduced, thus reducing fatigue endurance. Accordingly, the upper limit of the lattice constant is set to 2.890 Å. Particularly, it is preferable that the lattice constant be set to 2.881 Å to 2.890 Å to improve fatigue endurance. In order to obtain the lattice constant of 2.881 Å to 2.890 Å, it is preferable that the temperature be 450° C. to 500° C. during the nitriding treatment.

The lattice constant is measured using X-ray diffraction. However, since the surface of the oil-tempered wire or the spring is curved, it is difficult to precisely measure the lattice constant. Therefore, in the invention, a sample is produced by longitudinally cutting the oil-tempered wire (spring) having a predetermined length, and the longitudinal section of the sample is nitrided to measure the lattice constant of the nitride layer formed on the longitudinal section. It is considered that there is no difference between the lattice constant of the nitride layer which is obtained by nitriding treatment of the oil-tempered wire without the spring processing, and the lattice constant of the nitride layer which is obtained by nitriding treatment of the oil-tempered wire after the spring processing. Furthermore, the spring is frequently is subjected to shot peening after the nitriding treatment. In this case, the lattice constant of the nitride layer of the spring may be assumed by calculation using compressive residual stress of the nitride layer after the shot peening. In addition, the spring may be subjected to stress relieving annealing after the shot peening. In this case, it is considered that there is no difference between the lattice constants before and after the stress relieving annealing under the typical stress relieving annealing condition.

<Grain Size of Spherical Carbide>

As to the oil-tempered wire or the spring according to the invention, it is preferable that an average grain size of spherical carbides formed after the nitriding treatment and after the inside of the wire is subjected to the tempering process be 40 nm or less. Examples of carbides of the steel wire include insoluble carbides during quenching heating, and carbides formed and grown during heat treatment after the tempering. In the specification, the spherical carbides correspond to the latter carbides. The spherical carbides precipitated after the tempering process are coarsened and reduce strength of the steel wire if the stress relieving annealing or the nitriding treatment is performed after the spring processing, thus reducing fatigue endurance. If the size of the carbides is small and many types of carbide are precipitated, when external stress is applied, dislocation is shifted to prevent the carbides from being accumulated. Accordingly, the size of the average spherical carbide after the nitriding treatment is set to 40 nm or less. Preferably, the size of the spherical carbide is 30 nm or less, and more preferably, the size of the spherical carbides is 20 nm or less.

Furthermore, it is considered that there is no difference in the average grain size of the spherical carbides between the case of the nitriding treatment of the oil-tempered wire without the spring processing and the case of the nitriding treatment of the oil-tempered wire after the spring processing. In case the shot peening of the spring and the stress relieving annealing are sequentially performed after the nitriding treatment, it is considered that there is no difference in the average grain size of the spherical carbides before and after the stress relieving annealing under the typical stress relieving annealing condition.

<Change in Yield Stress According to Heat Treatment>

In an oil-tempered wire according to a second aspect of the invention, yield stress after heating for 2 hours at 420° C. to 500° C., and yield stress after heating for 4 hours at the same temperature are higher than yield stress after heating for 1 hour at the same temperature.

Currently, the oil-tempered wire is frequently subjected to the spring processing and then nitriding treatment. By using the nitriding treatment, hardness of the surface of the spring to which the maximum stress is applied is improved when the wire is used in the spring form, thereby increasing strength. If the known oil-tempered wire is subjected to the heat treatment corresponding to the nitriding treatment, a treating time is increased, thus reducing yield stress and tensile stress. That is, if the heat treatment corresponding to the nitriding treatment is performed to heat the steel wire at 420° C. to 500° C. for a long time, hardness of the inside of the steel wire is reduced, causing lengthening. Additionally, failure starts in the inside of the wire, thus reducing fatigue limit. The fatigue failure is caused by local and concentrated slip deformation (plastic deformation) due to repeated stress applied from the outside. To prevent this, it is necessary to improve yield stress. Yield stress after the heat treatment corresponding to the nitriding treatment is important.

Therefore, when the oil-tempered wire according to the invention is subjected to the heat treatment corresponding to the nitriding treatment, that is, when the heat treatment is performed at 420° C. to 500° C., the yield stress is not reduced even though the treating time is long. Thus, the yield stress is the same as or higher than the yield stress when the treating time is 1 hour. Accordingly, in case the oil-tempered wire is used as the material of the spring, the spring combines high fatigue strength and toughness.

In case the nitriding treatment is performed in the above-mentioned temperature range, when the treating time is less than 1 hour, the oil-tempered wire according to the invention may have reduced yield stress. Meanwhile, the typical treating time of the nitriding treatment is 2 to 4 hours. Accordingly, in the invention, the yield stresses when the treating time is 2 and 4 hours are compared with the yield stress when the treating time is 1 hour as the standard yield stress.

Particularly, it is preferable that the yield stress after the heating for 2 hours be higher than the yield stress after the heating for 1 hour at 420° C. to 500° C., and that the yield stress after the heating for 4 hours at the same temperature be higher than the yield stress after the heating for 2 hours at the same temperature. That is, in comparison with the yield stress when the treatment is performed for 1 hour, the oil-tempered wire where the yield stress increases as the treating time increases is used. Thereby, when the nitriding treatment is performed for a long time in accordance with the recent trend, the yield stress is improved and the oil-tempered wire for the spring has still better fatigue strength.

<Other Mechanical Properties>

In the oil-tempered wire according to the second aspect of the invention, preferably, tensile strength after the heating for 2 hours at 420° C. to 500° C. is lower than tensile strength after the heating for 1 hour at the same temperature, and tensile strength after the heating for 4 hours at the same temperature is lower than tensile strength after the heating for 2 hours at the same temperature. Due to the above-mentioned tendency of the tensile strength, it is possible to obtain high toughness after the nitriding treatment, and to prevent the development of the crack from the starting point of fatigue failure or damages due to intervention materials.

Preferably, the tensile strength after quenching tempering is 2000 MPa or more, and the yield stress after the heating at 420° C. to 500° C. for 2 hours is 1700 MPa or more. Alternatively, the tensile strength after the quenching tempering is 2000 MPa or more, and the yield stress after the heating at 420 to 450° C. for 2 hours is 1750 MPa or more. If the yield stress after the heating at the temperature of the nitriding treatment, that is, 420° C. to 500° C. is 1700 N/mm² or more, or if the yield stress after the heating at 420° C. to 450° C. is 1750 N/mm² or more, the fatigue endurance is significantly improved.

Preferably, a reduction of area after the heating at 420° C. to 500° C. for 2 hours is 35% or more. If the toughness of the matrix after the nitriding treatment is high, it is possible to prevent the development of the crack from the starting point of fatigue failure or damages due to inclusions, and to improve the fatigue endurance.

<Chemical Components of the Steel Wire>

It is preferable that the oil-tempered wire or the spring according to the invention contain, in terms of mass %, 0.50 to 0.75% of C, 1.50 to 2.50% of Si, 0.20 to 1.00% of Mn, 0.70 to 2.20% of Cr, 0.05 to 0.50% of V, and the balance including Fe and inevitable impurities. The oil-tempered wire or the spring may further contain 0.02 to 1.00% of Co in terms of mass %. The oil-tempered wire or the spring may further contain one or more selected from the group consisting of, in terms of mass %, 0.1 to 1.0% of Ni, 0.05 to 0.50% of Mo, 0.05 to 0.15% of W, 0.05 to 0.15% of Nb, and 0.01 to 0.20% of Ti. The reason why the amounts of the components are limited is as follows.

(C: 0.50 to 0.75 Mass %)

C is an important element that determines strength of steel. If the content of C is less than 0.50%, insufficient strength is obtained. If the content is more than 0.75%, toughness is reduced. Accordingly, the content is set to 0.50 to 0.75%.

(Si: 1.50 to 2.50 Mass %)

Si is used as a deoxidizing agent during melting. Further, Si is solid solved in ferrite to improve heat resistance and to prevent the stress relieving annealing after the spring processing or reduction in hardness of the inside of the wire due to the heat treatment, such as the nitriding treatment. In order to maintain the heat resistance, it is required that the content of Si is 1.5% or more. If the content is more than 2.5%, toughness is reduced. Accordingly, the content is set to 1.50 to 2.50%.

(Mn: 0.20 to 1.00 Mass %)

Like Si, Mn is used as a deoxidizing agent during the melting. Accordingly, a lower limit of the content required as the deoxidizing agent is set to 0.20%. If the content is more than 1.00%, martensite is easily formed during patenting, and the wire is broken during wire drawing. Therefore, an upper limit is set to 1.00%.

(Cr: 0.7 to 2.20 Mass %)

Since Cr improves quenching ability of the steel and increases softening resistance of the steel wire after the quenching tempering, Cr is useful to prevent softening during the heat treatment, such as the tempering treatment or the nitriding treatment, after the spring processing. In addition, in the nitriding treatment, Cr that is present in α-Fe is bonded to nitrogen to form nitrides, thus improving the surface hardness and increasing the lattice constant. Furthermore, in the austenitizing, Cr forms carbides, thereby reducing the grain size of austenite. Since an insufficient effect is obtained if the content of Cr is less than 0.7%, the content is set to 0.7% or more. If the content is more than 2.20%, martensite is easily formed during the patenting, causing breaking of the wire during the wire drawing and reduction in toughness after oil tempering. Therefore, the content is set to 0.7 to 2.20%.

(Co: 0.02 to 1.0 Mass %)

Co is solid solved in α-Fe to reinforce a matrix. Co does not form carbides and is not incrassated in cementite-based carbides. In order to grow the cementite-based carbides, Co must be discharged into α-Fe. Since diffusion of Co is slow, Co suppresses the growth of the cementite-based carbides. Furthermore, Co delays recovery of martensite, and reduces solubility of Cr or V in the matrix, thereby finely precipitating Cr carbides or V carbides on the residual dislocation. These effects are obtained when the content is 0.02% or more, and an upper limit is set to 1.00% or less because of high cost.

(Ni: 0.1 to 1.0 Mass %)

Ni has an effect on improvement of corrosion resistance and toughness. If the content of Ni is less than 0.1%, the effect is not obtained. If the content is more than 1.0%, additional improvement of toughness is not assured even though cost is increased. Thus, the content is set to 0.1 to 1.0%.

(Mo, V: 0.05 to 0.50 Mass %, and W, Nb: 0.05 to 0.15 Mass %)

These elements tend to form carbides and increase softening resistance during the tempering. V and Mo form nitrides between the lattices of α-Fe during the nitriding treatment. Thus, slip due to the repeatedly applied stress is suppressed, thereby contributing to improvement of fatigue endurance. However, if the content is less than 0.05%, the above-mentioned effects are not obtained. If the contents of Mo, V are more than 0.50%, and if the contents of W, Nb are more than 0.15%, toughness is reduced.

(Ti: 0.01 to 0.20 Mass %)

Ti forms carbides and has an effect on an increase in softening resistance of steel wire during the tempering. If the content of Ti is less than 0.01%, the effect is not assured. If the content is more than 0.20%, TiO that is a nonmetallic inclusion having a high melting point is formed, thus reducing toughness. Accordingly, the content is set to 0.01 to 0.20%.

[Production Method]

Meanwhile, the method of producing the oil-tempered wire according to the invention includes patenting, wire drawing, quenching, and tempering, and is roughly classified into an A type where a heating means and a keeping temperature in the quenching and a tempering condition are regulated, and a B type where a cooling rate during the patenting or a heating rate during the quenching are regulated.

First, referring to the A type, the A type is divided into an A-1 type where the quenching heating is performed using radiation heating, and an A-2 type where the quenching heating is performed using high frequency induction heating.

The A-1 type is the method of producing the oil-tempered wire which includes quenching and tempering the steel wire after a wire drawing process. The quenching process is performed after the heating is conducted at 850° C. to 950° C. for over 30 sec to 150 sec using the radiation heating. The tempering process is performed at 400° C. to 600° C.

It is preferable that the tempering process be a two-step tempering process having a first tempering process and a second tempering process. The temperature of the first tempering process is 400° C. to 470° C. The second tempering process is performed at a temperature higher than that of the first tempering process after the first tempering process without intermission. The temperature of the second tempering process is 450° C. to 600° C.

Next, the A-2 type is the method of producing the oil-tempered wire which includes quenching and tempering the steel wire after the wire drawing process. The quenching process is performed after the heating is conducted at 900° C. to 1050° C. for 1 sec to 10 sec using the high frequency induction heating. Furthermore, the tempering process is a two-step tempering process having a first tempering process and a second tempering process. The temperature of the first tempering process is 400° C. to 470° C. The second tempering process is performed at a temperature higher than that of the first tempering process after the first tempering process without intermission. The temperature of the second tempering process is 450° C. to 600° C.

<Austenitizing Condition>

As to the austenitizing of a steel wire structure by heating before the quenching, it is important to dissolve insoluble carbides so that toughness is improved and austenite grains are not coarsened. If the grain size of the austenite grains is excessively small, the insoluble carbides remain. Thus, since toughness and fatigue endurance of the oil-tempered wire are reduced, it is preferable that the grain size be 3.0 μm to 7.0 μm. In order to sufficiently dissolve the insoluble carbides and satisfy the above-mentioned desirable grain size, in the case of the radiation heating, the heating temperature is 850° C. to 950° C. and the heating time is over 30 sec to 150 sec. In the case of the high frequency induction heating, the heating temperature is 900° C. to 1050° C. and the heating time is 1 sec to 10 sec. The heating temperature means a set temperature of a heater in both cases of the radiation heating and the high frequency induction heating.

<Tempering Condition>

If the heating is the radiation heating before quenching, the tempering may be performed through one step in the continuous temperature range, or may be performed through two steps. Additionally, if the heating is the high frequency induction heating before the quenching, the tempering is performed through two steps.

In case the radiation heating is performed before the quenching and the tempering is conducted through one step, if the temperature of the tempering is lower than 400° C., since recovery of martensite is undesirable, toughness is poor, thus reducing fatigue endurance. On the contrary, if the temperature of the tempering is higher than 600° C., since carbides are coarsened, strength is reduced, thus reducing fatigue endurance.

Meanwhile, the reason why the tempering is performed through two steps is as follows. As to precipitation of carbides during the tempering, ξ-carbides (Fe₂C) are precipitated at 400° C. to 470° C. If ξ-carbides are coarsened at 450° C. to 600° C., softening (weakness) occurs. Thus, change to cementite-based carbides (Fe₃C) having reduced strength is performed. If the first tempering is performed at low temperatures of 400° C. to 470° C. to precipitate ξ-carbides, the change to the cementite-based carbides is delayed during the second tempering due to actions of Si or Co, thus suppressing coarsening of carbides during the second tempering process or the nitriding process. Accordingly, the first tempering is performed at 400° C. to 470° C., and the second tempering is performed at 450° C. to 600° C. that is higher than that of the first tempering.

If the temperature of the first tempering is less than 400° C., or if the temperature of the second tempering is less than 450° C., since recovery of martensite is undesirable, toughness is poor, thus reducing fatigue endurance. Additionally, if the temperature of the first tempering is higher than 470° C., or if the temperature of the second tempering is higher than 600° C., carbides are coarsened to reduce strength, causing reduction in fatigue endurance. Accordingly, the temperature of the first tempering is set to 400° C. to 470° C., and the temperature of the second tempering is set to 450° C. to 600° C. Particularly, in case the heating is performed using the high frequency induction heating before the quenching, since the cementite-based carbides are easily coarsened due to the rapid heating rate, it is preferable to perform the tempering through two steps.

It is preferable that a difference in temperature of the first tempering and the second tempering be 20° C. to 200 C. If the difference is lower than the lower limit, the effect that is obtained by performing the tempering through two steps is insignificant.

The keeping time of the tempering is set to, for example, 30 to 60 seconds when the tempering is performed through one step. When the tempering is performed through two steps, the total keeping time of the first tempering and the second tempering is set to 30 to 60 seconds. The above-mentioned keeping time is required to assure appropriate toughness of the oil-tempered wire.

Next, the B type is the method of producing the oil-tempered wire which includes patenting steel wire, wire drawing the patented steel wire, and quenching and tempering the wire drawn steel wire. The B type satisfies at least two conditions of (1) a cooling condition of the patenting, (2) a heating rate to 600° C. before the quenching, and (3) a heating rate of from 600° C. to the keeping temperature. In detail, the B type is classified into the following three types.

B-1 type: During the patenting process, the steel wire is austenitized, cooled at a cooling rate of 10° C./sec to 20° C./sec using air cooling, and kept at a predetermined temperature to conduct perlite transformation. The steel wire is heated from a room temperature to 600° C. at a heating rate from 20° C./sec to less than 50° C./sec before the quenching process.

B-2 type: During the patenting process, the steel wire is austenitized, cooled at a cooling rate of 10° C./sec to 20° C./sec using air cooling, and kept at a predetermined temperature to conduct perlite transformation. The steel wire is heated from 600° C. to a keeping temperature at a heating rate of 5° C./sec to 20° C./sec during the quenching.

B-3 type: During the quenching process, the steel wire is heated at a heating rate from 20° C./sec to less than 50° C./sec in a range of from room temperature to 600° C. and at a heating rate of 5° C./sec to 20° C./sec in a range of from 600° C. to a keeping temperature.

<Cooling Condition after the Austenitizing During the Patenting>

Generally, the patenting means heat treatment that is performed to improve wire drawing ability by forming homogeneous perlite structures in piano wires or hard drawn steel wires. In the invention, air cooling is performed to achieve cooling after the austenitizing of the patenting. If the air cooling is performed, the production may be feasible at lower cost in comparison with use of a lead furnace or a fluidized bed. Furthermore, if the cooling rate is set to 10° C./sec to 20° C./sec and cementite of perlite is made thin, the insoluble carbides are solid solved after the quenching. If the cooling rate after the austenitizing is less than 10° C./sec, the cementite layer of perlite is made thick, and the insoluble carbides remain after the quenching. Further, if the cooling rate is more than 20° C./sec, martensite is formed and the wire drawing ability is reduced. Accordingly, the cooling rate is set in the above-mentioned range.

<Heating Rate in the Range of from Room Temperature to 600° C. Before the Quenching>

With respect to the quenching, the steel wire is heated in advance. When the heating is performed, cementite of perlite has a sphere shape in the range of from room temperature to 600° C., thus being coarsened. If cementite is coarsened, cementite remains as the insoluble carbides after the quenching, thus reducing toughness. In order to prevent cementite from being coarsened, here, the lower limit of the heating rate is set to 20° C./sec. Since there is no difference in effect even though the heating rate is set to 50° C./sec or more, the upper limit is set to be less than 50° C./sec.

<Heating Rate in the Range of from 600° C. to the Keeping Temperature Before the Quenching>

Cementite that has the spherical shape at 600° C. or higher is solid solved in matrix in the heating process before the quenching. If cementite is sufficiently solid solved, the amount of insoluble carbides may be reduced after the quenching, and the matrix is reinforced to improve yield stress after the nitriding treatment. Accordingly, the heating rate is set as low as possible to dissolve the insoluble carbides (cementite). Therefore, the upper limit of the heating rate is set to 20° C./sec. Additionally, in case the heating rate is lower than 5° C./sec, since the austenite grains are coarsened, the lower limit is set to 5° C./sec.

<Others>

Typically, the oil-tempered wire is produced by melting steel wire having predetermined chemical components, hot forging and hot rolling the steel wire to form rolled wire rods, patenting, shaving, annealing, wire drawing, quenching, and tempering the rods. In this procedure, the chemical components of the molten steel may correspond to the above-mentioned chemical components.

In case the spring is produced using the oil-tempered wire, the oil-tempered wire is subjected to spring processing. Subsequently, for example, low temperature annealing, nitriding treatment, shot peening, and stress relieving annealing are sequentially performed.

FIG. 1 illustrates a temperature profile of a procedure ranging from a middle step of the production of the oil-tempered wire to the production of the spring. In connection with this, the tempering is performed through two steps of a first tempering step and a second tempering step. To perform the second tempering after the first tempering without intermission means that the second tempering is performed immediately after the first tempering is performed without cooling as shown in the profile.

### EFFECTS OF THE INVENTION

An oil-tempered wire and a spring according to the invention are capable of combining fatigue limit and toughness. Particularly, it is possible to provide the oil-tempered wire and the spring having excellent fatigue endurance after nitriding treatment.

According to a method of producing an oil-tempered wire of the invention, a cooling condition during patenting and a heating condition during quenching, or an austenitizing condition during the quenching and a tempering condition are regulated to produce the oil-tempered wire that combines fatigue endurance and toughness.

### BEST MODE FOR CARRYING OUT THE INVENTION

A better understanding of the present invention may be obtained in light of the following examples.

### Example 1

(1) Steels of material according to the invention and comparative material having the chemical components shown in Table 1 were melted in a vacuum melting furnace, and subjected to hot forging and hot rolling to produce rods of φ6.5 mm. Next, the rods were subjected to patenting, shaving, annealing, and wire drawing to produce wires of φ3.5 mm. The cooling rate was set to 7° C./sec in the range of from the austenitizing temperature to the keeping temperature during the patenting, and the heating rate was constantly set to 15° C./sec in the range of from room temperature to the keeping temperature during the quenching.

(2) The resulting wires were subjected to quenching tempering under the conditions as described later to produce oil-tempered wires. The wires were heated to austenitize the steel structures, and then immersed in oil to perform the quenching. After the quenching, the rods were passed through molten lead to perform the tempering.

(3) The resulting oil-tempered wire was nitrided. The nitriding treatment was gas nitrocaburizing, and performed at 420, 450, and 500° C. for 2 hours.

(4) With respect to the oil-tempered wires before the nitriding treatment, an average grain size of austenite was measured, insoluble carbides were observed during the quenching, and a reduction of area was measured. With respect to the oil-tempered wires after the nitriding treatment, the lattice constant of the nitride layer on the surface of the wire was measured, the size of carbide formed after the tempering process was measured, and a fatigue test was performed. The above-mentioned measurements and tests were selectively performed according to experimental examples as described later.

(5) The average grain size of austenite (γ grain size) was calculated using a cutting method defined in JIS G 0552.

(6) In order to observe whether the insoluble carbides were present or not, the oil-tempered wires were randomly photographed using the TEM (Transmission Electron Microscope) after the quenching tempering. In case any one of the insoluble carbide particles was observed in pictures of 5 viewing fields (area 40 μm²/viewing field), the insoluble carbides were considered to be present. In case no insoluble carbide particles were observed, the insoluble carbides were considered to be not present.

(7) A test sample No. 9 of JIS Z 2201 was subjected to a tensile test based on JIS Z 2241. A difference between the minimum sectional area A of the fractured test sample and the original sectional area Ao of the test sample was divided by the original sectional area Ao of the test sample to calculate the percentage % of the reduction of area. The set value of the reduction of area is 40% or more.

(8) The measurement of the lattice constant was performed using the X-Ray Diffractometer (RINT 1500×-ray diffractometer manufactured by Rigaku Corp.). In the precise measurement of the lattice constant, the diffraction peak at high diffraction angles 2θ was used. However, in the present example, the clear diffraction peak was not obtained after the nitriding treatment. Therefore, all the diffraction lines in the vicinity of 130 degrees capable of being detected at low angles were used. Moreover, the angle correction of the diffraction angle was performed by using Si powder as a standard sample. Since the surface of the oil-tempered wire was curved, it was difficult to measure the exact lattice constant. Therefore, the longitudinal section of the oil-tempered wire was nitrided to measure the lattice constant of the nitride layer of the longitudinal section.

(9) The image analysis was performed on the basis of pictures of 5 viewing fields (area 2 μm²/viewing field) of the oil-tempered wires that were randomly photographed using the TEM, and areas of carbides were calculated. Carbides were considered to have the sphere shape, and the average diameter was calculated to obtain the size of carbide formed after the tempering process.

(10) After the nitrided oil-tempered wire was subjected to shot peening (0.2 SB, 20 minutes), the stress relieving annealing was performed (230° C.×30 minutes), and the Nakamura-type rotation bending fatigue test was conducted to perform the fatigue test. A limit of fatigue was set to 1×10⁷ times, and fatigue limit of an object was set to 1150 MPa or more.

The chemical components of the material according to the invention and the comparative material are described in Table 1. All numerical values of Table 1 are shown in a mass % unit, and “*” denotes that it is outside the range of amounts of components defined in claim 12 or 13.

Moreover, in the experimental examples as described later, there were insignificant differences in the lattice constant and the size of carbide between the oil-tempered wire according to the invention and the comparative material after the quenching tempering.

TABLE 1

| | Type of steel | C | Si | Mn | Cr | V | Co | Balance |
|---|---|---|---|---|---|---|---|---|
| Material according | A | 0.65 | 2.21 | 0.55 | 1.20 | 0.15 | 0.23 | — |
| to the invention | B | 0.74 | 2.48 | 0.86 | 0.72 | 0.07 | — | — |
| | C | 0.52 | 1.60 | 0.22 | 2.12 | 0.48 | 0.94 | — |
| | D | 0.70 | 2.31 | 0.32 | 1.35 | 0.21 | 0.51 | — |
| | E | 0.65 | 2.23 | 0.54 | 1.22 | 0.16 | 0.50 | Ni: 0.51 |
| | F | 0.64 | 2.21 | 0.58 | 1.18 | 0.14 | 0.22 | Mo: 0.32 |
| | G | 0.63 | 2.19 | 0.62 | 1.19 | 0.13 | 0.21 | W: 0.08 |
| | H | 0.67 | 2.25 | 0.58 | 1.26 | 0.17 | 0.28 | Nb: 0.09 |
| | I | 0.64 | 2.15 | 0.70 | 1.08 | 0.15 | 0.40 | Ti: 0.11 |
| Comparative material | J | 0.65 | 1.47* | 1.13* | 1.35 | 0.11 | 0.30 | — |
| | K | 0.68 | 2.41 | 0.75 | 0.42* | 0.20 | 0.05 | — |
| | L | 0.78* | 1.92 | 0.18* | 2.61* | 0.45 | 0.01* | — |
| | M | 0.48* | 2.67* | 0.52 | 0.31* | 0.06 | 1.13* | — |
| | N | 0.58 | 2.23 | 0.35 | 0.57* | 0.03* | 0.53 | Mo: 0.63 |
| | O | 0.64 | 2.43 | 0.45 | 1.14 | 0.65* | 0.30 | Ni: 1.05 |

### Experimental Example 1-1

### Radiation Heating+Two-Step Tempering

The lattice constant of the nitride layer, the size of the carbide formed after the tempering process, and the γ grain size were measured while gas nitrocaburizing conditions were changed using the types of steel shown in Table 1, and the results of the fatigue test was obtained. The austenitizing condition during the quenching included the radiation heating, the heating temperature of 900° C., and the heating time of 90 sec. With respect to the tempering condition, the two-step tempering process was performed. The first tempering condition included 430° C.×30 sec, and the second tempering condition included 540° C.×30 sec.

The test results are described in Tables 2 to 4. Table 2 shows the test results when the gas nitrocaburizing condition included 420° C.×2 hours. Table 3 shows the test results when the gas nitrocaburizing condition included 450° C.×2 hours. Table 4 shows the test results when the gas nitrocaburizing condition included 500° C.×2 hours. Further, in Tables 2 to 4, “*” denotes that it is outside the conditions defined in claim 1 or 5.

TABLE 2

| | Lattice | Carbide | γ grain | Fatigue |
|---|---|---|---|---|
| Type of steel | constant(\acute{Å}) | size(nm) | size(μm) | Limit(MPa) |
| A | 2.873 | 21 | 4.8 | 1200 |
| B | 2.871 | 25 | 4.9 | 1195 |
| C | 2.874 | 20 | 4.5 | 1215 |
| D | 2.872 | 21 | 4.5 | 1210 |
| E | 2.872 | 22 | 4.5 | 1215 |
| F | 2.873 | 22 | 4.5 | 1215 |
| G | 2.872 | 21 | 4.5 | 1220 |
| H | 2.872 | 22 | 4.2 | 1215 |
| I | 2.872 | 23 | 4.1 | 1200 |
| J | — | — | — | — |
| K | 2.866* | 27 | 4.5 | 1125 |
| L | 2.891* | 42* | 4.6 | 1145 |
| M | 2.867* | 18 | 4.5 | 1130 |
| N | — | — | — | — |
| O | — | — | — | — |

TABLE 3

| | Lattice | Carbide | γ grain | Fatigue |
|---|---|---|---|---|
| Type of steel | constant(\acute{Å}) | size(nm) | size(μm) | Limit(MPa) |
| A | 2.885 | 23 | 4.3 | 1225 |
| B | 2.883 | 28 | 4.9 | 1220 |
| C | 2.886 | 22 | 4.5 | 1235 |
| D | 2.884 | 23 | 4.3 | 1235 |
| E | 2.885 | 24 | 4.5 | 1230 |
| F | 2.884 | 24 | 4.5 | 1230 |
| G | 2.885 | 25 | 4.5 | 1225 |
| H | 2.884 | 24 | 4.2 | 1225 |
| I | 2.885 | 26 | 4.1 | 1225 |
| J | — | — | — | — |
| K | 2.868* | 32 | 4.5 | 1130 |
| L | 2.893* | 48* | 4.6 | 1140 |
| M | 2.868* | 22 | 4.5 | 1135 |
| N | — | — | — | — |
| O | — | — | — | — |

TABLE 4

| | Lattice | Carbide | γ grain | Fatigue |
|---|---|---|---|---|
| Type of steel | constant(\acute{Å}) | size(nm) | size(μm) | Limit(MPa) |
| A | 2.889 | 28 | 4.8 | 1240 |
| B | 2.887 | 32 | 4.9 | 1230 |
| C | 2.890 | 25 | 4.5 | 1245 |
| D | 2.889 | 28 | 4.7 | 1230 |
| E | 2.889 | 27 | 4.5 | 1230 |
| F | 2.887 | 26 | 4.5 | 1235 |
| G | 2.888 | 28 | 4.5 | 1235 |
| H | 2.887 | 26 | 4.2 | 1225 |
| I | 2.889 | 27 | 4.1 | 1235 |
| J | — | — | — | — |
| K | 2.869* | 43* | 4.5 | 1135 |
| L | 2.894* | 53* | 4.6 | 1135 |
| M | 2.869* | 31 | 4.5 | 1140 |
| N | — | — | — | — |
| O | — | — | — | — |

From the above Tables, it can be apparently seen that the material according to the invention had high fatigue limit at all nitriding temperatures. Meanwhile, as to the comparative material K, the lattice constant of the nitride layer was small when the nitriding treatment was performed at 420° C. and 450° C., and the grain size of carbide was larger when the nitriding treatment was performed at 500° C. The lattice constant and the carbide size of the comparative material L were both large. Since the comparative M has the small lattice constant, the fatigue limit was reduced. Furthermore, as to the comparative materials J and N, since martensite was formed during the patenting, the wire drawing disconnection occurred. As to the comparative material O, since the amount of V added was great and toughness was low, the disconnection occurred during the wire drawing process. Thus, it was impossible to perform the fatigue test.

### Experimental Example 1-2

### Radiation Heating+Two-Step Tempering

With respect to the change of the austenitizing condition during the quenching using the radiation heating by means of the material A according to the invention and the comparative material K, the correlation of the austenitizing condition and the insoluble carbide, the correlation of the austenitizing condition and the γ grain size, and the results of the fatigue test were evaluated.

As to the austenitizing condition, the heating temperature was set to 800° C., 860° C., 900° C., 940° C., and 1000° C., and the heating time was set to 10 sec, 40 sec, 90 sec, 140 sec, and 180 sec. The tempering was performed through two steps. The first tempering condition included 430° C.×30 sec, and the second tempering condition included 540° C.×30 sec. The nitriding condition included 450° C.×2 hours.

The correlations of the austenitizing condition and the insoluble carbide for the material A according to the invention and the comparative material K are shown in FIGS. 2 and 3, respectively. The correlations of the austenitizing condition and the γ grain size for the material A according to the invention and the comparative material K are shown in FIGS. 4 and 5, respectively. Furthermore, the results of measurement of the lattice constant of the nitride layer, the size of carbide formed after the tempering process, and the γ grain size, and the results of the fatigue test for the sample Nos. 1 to 10 of FIGS. 2 and 3 are described in Table 5.

TABLE 5

| | | | γ grain | Fatigue | |
|---|---|---|---|---|---|
| Sample | Lattice | Carbide | size | limit | |
| No. | constant (\acute{Å}) | size (nm) | (μm) | (MPa) | Remark |
| 1 | 2.885 | 22 | 2.5 | 1170 | Insoluble carbide |
| | | | | | observed |
| 2 | 2.885 | 21 | 3.4 | 1235 | |
| 3 | 2.885 | 22 | 4.6 | 1225 | |
| 4 | 2.885 | 23 | 6.2 | 1210 | |
| 5 | 2.885 | 22 | 8.1 | 1185 | |
| 6 | 2.868 | 22 | 3.3 | 1135 | Insoluble carbide |
| | | | | | observed |
| 7 | 2.868 | 23 | 4.1 | 1135 | |
| 8 | 2.868 | 24 | 5.3 | 1130 | |
| 9 | 2.868 | 23 | 6.8 | 1125 | |
| 10 | 2.868 | 23 | 9.1 | 1125 | |

Consequently, the sample Nos. 2, 3, and 4 of the material A according to the invention had high fatigue limit. However, the sample No. 1 having the insoluble carbide, and the sample No. 5 where the γ grain size was more than 7.0 μm had slightly low fatigue limit. The comparative material K had the lattice constant of less than 2.870 Å for all the cases, and also had fatigue limit that was lower than the set value of 1150 MPa.

Additionally, the TEM picture of the sample No. 1 is shown in FIG. 6(A), and the TEM picture of the sample No. 2 is shown in FIG. 6(B). Both were pictures of the structures of the oil-tempered wires after the nitriding treatment. In the picture of FIG. 6A, black circles are insoluble carbides during the quenching. In the picture of FIG. 6(B), small black circles are carbides precipitated during the tempering. From comparison of both pictures, it can be apparently seen that, since the insoluble carbide was still larger than the carbide precipitated during the tempering process, it was possible to apparently distinguish two carbides.

### Experimental Example 1-3

### High Frequency Induction Heating+Two-Step Tempering

With respect to the change of the austenitizing condition using the high frequency induction heating by means of the material A according to the invention and the comparative material K, the correlation of the austenitizing condition and the insoluble carbide, the correlation of the austenitizing condition and the γ grain size, and the results of the fatigue test were evaluated.

As to the austenitizing condition, the heating temperature was set to 850° C., 910° C., 970° C., 1040° C., and 1100° C., and the heating time was set to 0.5 sec, 2 sec, 5 sec, 8 sec, and 20 sec. The tempering was performed through two steps. The first tempering condition included 430° C.×30 sec, and the second tempering condition included 540° C.×30 sec. The nitriding condition included 450° C.×2 hours.

The correlations of the austenitizing condition and the insoluble carbide for the material A according to the invention and the comparative material K are shown in FIGS. 7 and 8, respectively. The correlations of the austenitizing condition and the γ grain size for the material A according to the invention and the comparative material K are shown in FIGS. 9 and 10, respectively. Furthermore, the results of measurement of the lattice constant of the nitride layer, the size of carbide formed after the tempering process, and the γ grain size, and the results of the fatigue test for the sample Nos. 11 to 20 of FIGS. 7 and 8 are described in Table 6.

TABLE 6

| | | | γ grain | Fatigue | |
|---|---|---|---|---|---|
| Sample | Lattice | Carbide | size | limit | |
| No. | constant (\acute{Å}) | size (nm) | (μm) | (MPa) | Remark |
| 11 | 2.885 | 23 | 2.7 | 1175 | Insoluble carbide |
| | | | | | observed |
| 12 | 2.885 | 22 | 3.7 | 1230 | |
| 13 | 2.885 | 21 | 5.3 | 1225 | |
| 14 | 2.885 | 22 | 6.4 | 1220 | |
| 15 | 2.885 | 23 | 8.1 | 1185 | |
| 16 | 2.868 | 22 | 2.8 | 1135 | Insoluble carbide |
| | | | | | observed |
| 17 | 2.868 | 23 | 3.9 | 1140 | |
| 18 | 2.868 | 22 | 5.6 | 1130 | |
| 19 | 2.868 | 23 | 6.6 | 1130 | |
| 20 | 2.868 | 22 | 8.5 | 1125 | |

Consequently, the sample Nos. 12, 13, and 14 of the material A according to the invention had high fatigue limit. However, the sample No. 11 having the insoluble carbide, and the sample No. 15 where the γ grain size was more than 7.0 μm had slightly low fatigue limit. The comparative material K had the lattice constant of less than 2.870 Å for all the cases, and also had fatigue limit that was lower than the set value of 1150 MPa.

### Experimental Example 1-4-1

### Radiation Heating+Two-Step Tempering

With respect to the change of the tempering condition after the quenching while the heating was performed at 900° C. for 90 sec using the radiation heating by means of the material A according to the invention and the comparative material K, the correlation of the first and the second tempering temperatures and the reduction of area, and the correlation of the first tempering condition and the size of carbide formed after the tempering process were evaluated.

The first tempering temperature was set to 350° C., 410° C., 430° C., 460° C., and 520° C. for 30 sec. The second tempering temperature was set to 420° C., 480° C., 540° C., 590° C., and 650° C. for 30 sec. The nitriding condition included 450° C.×2 hours.

The correlations of the tempering condition and the reduction of area for the material A according to the invention and the comparative material K are shown in FIGS. 11 and 12, respectively. The correlations of the tempering condition and the size of carbide for the material A according to the invention and the comparative material K are shown in FIGS. 13 and 14, respectively. Furthermore, the results of measurement of the lattice constant of the nitride layer, the size of carbide formed after the tempering process, the γ grain size, and the reduction of area, and the results of the fatigue test for the sample Nos. 21 to 30 of FIGS. 11 and 12 are described in Table 7.

TABLE 7

| | | | | Reduction of | Fatigue |
|---|---|---|---|---|---|
| Sample | Lattice | Carbide | γ grain | area | Limit |
| No. | constant (\grave{Å}) | size (nm) | size (μm) | (%) | (MPa) |
| 21 | 2.885 | 19 | 4.6 | 27 | 1180 |
| 22 | 2.885 | 25 | 4.6 | 40 | 1235 |
| 23 | 2.885 | 29 | 4.6 | 43 | 1225 |
| 24 | 2.885 | 35 | 4.6 | 47 | 1225 |
| 25 | 2.885 | 50 | 4.6 | 52 | 1195 |
| 26 | 2.868 | 22 | 5.3 | 25 | 1115 |
| 27 | 2.868 | 27 | 5.3 | 31 | 1135 |
| 28 | 2.868 | 31 | 5.3 | 41 | 1130 |
| 29 | 2.868 | 38 | 5.3 | 45 | 1125 |
| 30 | 2.868 | 53 | 5.3 | 48 | 1120 |

Consequently, the sample Nos. 22, 23, and 24 of the material A according to the invention had high fatigue limit. However, since the sample No. 21 had low reduction of area after the quenching tempering, toughness was poor. Since the carbides of the sample No. 25 were coarsened, the sample No. 25 had slightly low fatigue limit. The sample Nos. 26, 27, 28, 29, and 30 of the comparative material K had the small lattice constant after the nitriding treatment. The sample No. 26 had low reduction of area, and the carbides of the sample No. 30 were coarsened. Thus, the sample Nos. 26, 27, 28, 29, and 30 had the lower fatigue limit.

### Experimental Example 1-4-2

### Radiation Heating+One-Step Tempering

With respect to the change of the tempering condition during the one-step tempering after the quenching while the heating was performed at 900° C. for 90 sec using the radiation heating by means of the material A according to the invention and the comparative material K, the results of measurement of the lattice constant of the nitride layer, the size of carbide formed after the tempering process, the γ grain size, and the reduction of area, and the results of the fatigue test are described in Table 8.

The tempering condition included 350° C., 480° C., 540° C., 590° C., and 650° C.×60 sec. The nitriding condition included 450° C.×2 hours.

TABLE 8

| Type | | Tempering | | | | Reduction | Fatigue |
|---|---|---|---|---|---|---|---|
| of | Sample | temperature | Lattice | Carbide | γ grain | of area | limit |
| steel | No. | (° C.) | constant (\grave{Å}) | size (nm) | size (μm) | (%) | (MPa) |
| A | 31 | 350 | 2.885 | 13 | 4.6 | 21 | 1165 |
| A | 32 | 480 | 2.885 | 35 | 4.6 | 37 | 1215 |
| A | 33 | 540 | 2.885 | 38 | 4.6 | 45 | 1220 |
| A | 34 | 590 | 2.885 | 40 | 4.6 | 48 | 1220 |
| A | 35 | 650 | 2.885 | 53 | 4.6 | 55 | 1175 |
| K | 36 | 350 | 2.868 | 15 | 5.3 | 18 | 1090 |
| K | 37 | 480 | 2.868 | 36 | 5.3 | 35 | 1125 |
| K | 38 | 540 | 2.868 | 40 | 5.3 | 40 | 1130 |
| K | 39 | 590 | 2.868 | 43 | 5.3 | 43 | 1130 |
| K | 40 | 650 | 2.868 | 53 | 5.3 | 45 | 1100 |

Consequently, since the sample No. 31 of the material A according to the invention had low reduction of area after the quenching tempering and the carbides of the sample No. 35 were coarsened, the material A according to the invention had slightly low fatigue limit. The comparative material K had the small lattice constant after the nitriding for all the cases, and also had fatigue limit that was lower than the set value of 1150 MPa.

### Experimental Example 1-5

### High Frequency Induction Heating+Two-Step Tempering

Next, an experimental example of the change of the tempering condition after the quenching while the heating was performed at 970° C. for 1 sec using the high frequency induction heating by means of the material A according to the invention and the comparative material K is described.

The first tempering temperature was set to 350° C., 410° C., 430° C., 460° C., and 520° C. for 30 sec. The second tempering temperature was set to 420° C., 480° C., 540° C., 590° C., and 650° C. for 30 sec. The nitriding condition included 450° C.×2 hours.

The correlations of the tempering condition and the reduction of area for the material A according to the invention and the comparative material K are shown in FIGS. 15 and 16, respectively. The correlations of the tempering condition and the size of carbide for the material A according to the invention and the comparative material K are shown in FIGS. 17 and 18, respectively. Furthermore, the results of measurement of the lattice constant of the nitride layer, the size of carbide formed after the tempering process, the γ grain size, and the reduction of area, and the results of the fatigue test for the sample Nos. 41 to 50 of FIGS. 15 and 16 are described in Table 9.

TABLE 9

| | | | | Reduction of | Fatigue |
|---|---|---|---|---|---|
| Sample | Lattice | Carbide | γ grain | area | Limit |
| No. | constant (\grave{Å}) | size (nm) | size (μm) | (%) | (MPa) |
| 41 | 2.885 | 20 | 3.1 | 28 | 1185 |
| 42 | 2.885 | 24 | 3.1 | 41 | 1240 |
| 43 | 2.885 | 28 | 3.1 | 43 | 1240 |
| 44 | 2.885 | 34 | 3.1 | 48 | 1235 |
| 45 | 2.885 | 51 | 3.1 | 52 | 1195 |
| 46 | 2.868 | 22 | 3.3 | 26 | 1110 |
| 47 | 2.868 | 25 | 3.3 | 35 | 1135 |
| 48 | 2.868 | 29 | 3.3 | 41 | 1145 |
| 49 | 2.868 | 36 | 3.3 | 44 | 1140 |
| 50 | 2.868 | 53 | 3.3 | 48 | 1120 |

Consequently, the sample Nos. 42, 43, and 44 of the material A according to the invention had high fatigue limit. However, since the sample No. 41 had low reduction of area after the quenching tempering, toughness was poor. Since the carbides of the sample No. 45 were coarsened, the sample No. 45 had slightly low fatigue limit. The sample Nos. 46, 47, 48, 49, and 50 of the comparative material K had the small lattice constant after the nitriding. The sample No. 46 had low reduction of area, and the carbides of the sample No. 50 were coarsened. Thus, the sample Nos. 46, 47, 48, 49, and 50 had the lower fatigue limit.

### Experimental Example 1-6

### Spring

The oil-tempered wire of the sample No. 2 of FIG. 2 was subjected to spring processing, and then low temperature annealing to produce a spring. The spring had a coil average diameter of 20 mm, a free length of 50 mm, an effective winding number of 5, and a total winding number of 7. The low temperature annealing was performed at 230° C. for 30 min. The longitudinal section sample of the rod of the resulting spring was prepared, the longitudinal section of the sample was nitrided at 450° C. for 2 hours to measure the lattice constant of the nitride layer formed on the longitudinal section. Additionally, the longitudinal section sample was prepared using the oil-tempered wire that was not subjected to the spring processing, and the longitudinal section was nitrided, and the lattice constant of the nitride layer was measured.

Consequently, all lattice constants were within the range of from 2.870 Å to 2.890 Å. There was an insignificant difference in the lattice constant of the samples.

### Example 2

(1) Steels of material according to the invention and comparative material shown in Table 1 were melted in a vacuum melting furnace, and subjected to hot forging and hot rolling to produce rods of φ6.5 mm. Next, the rods were subjected to patenting, shaving, annealing, and wire drawing under the condition as described later to produce wires of φ3.5 mm.

(2) The resulting wires were subjected to patenting and quenching tempering under the condition as described later to produce oil-tempered wires. The wires were heated to austenitize the steel structures, and then immersed in oil (room temperature) to perform the quenching. After the quenching, the rods were passed through molten lead to perform the tempering.

(3) Next, the oil-tempered wire was heat treated under the condition corresponding to the nitriding condition of 420° C., 450° C., and 500° C.×1 hour, 2 hours, and 4 hours.

(4) With respect to the oil-tempered wires before the heat treatment corresponding to the nitriding, an average grain size of austenite was measured, and insoluble carbides were observed during the quenching. With respect to the oil-tempered wires after the heat treatment, yield stress, tensile strength, and reduction of area were measured, the size of carbide formed after the tempering process was measured, and a fatigue test was performed. In addition, the oil-tempered wires were nitrided to measure the lattice constant of the nitride layer on the surface of the wire.

(5) The yield stress and the tensile strength were measured based on JIS Z 2241. The yield stress was calculated using an offset method where permanent elongation was 0.2%. The set value of the reduction of area was 35%.

(6) In order to observe whether the insoluble carbides were present or not, the oil-tempered wires were randomly photographed using the TEM after the quenching tempering. In case any one of the insoluble carbide particles was observed in pictures of 5 viewing fields (area 40 μm²/viewing field), the insoluble carbides were considered to be present. A symbol x was used for the case of the average grain size of 200 nm or more, and a symbol Δ was used for the case of the average grain size from 100 nm to less than 200 nm. In a case where the insoluble carbides were not observed, the insoluble carbides were considered to be not present and a symbol ◯ was used.

(7) After the quenching tempering, the heat treatment for the nitriding was performed under the condition of 420° C., 450° C., and 500° C., and 1 hour, 2 hours, and 4 hours. Next, shot peening (0.2 SB, 20 minutes) and the stress relieving annealing were performed (230° C.×30 minutes), and the Nakamura-type rotation bending fatigue test was conducted to perform the fatigue test. A limit of fatigue was set to 1×10⁷ times, and the set value was 1150 MPa or more.

(8) The average grain size of austenite, the reduction of area, the size of carbide formed after the tempering process, and the lattice constant were obtained through the same procedure as example 1.

### Experimental Example 2-1

### The Patenting Condition and the Heating Rate 1 Before the Quenching

With respect to all components shown in Table 1, the oil-tempered wire was produced under the following condition based on the temperature profile shown in FIG. 19. The “cooling rate A” of FIG. 19 is the “cooling rate after the austenitizing during the patenting”, the “heating rate A” of FIG. 19 is the “heating rate (room temperature to 600° C.) before the quenching”, and the “heating rate B” of FIG. 19 is the “heating rate (600 to the keeping temperature) before the quenching”. The test results of the resulting oil-tempered wire for the above-mentioned evaluation items are shown in Tables 10 to 18. In the above-mentioned Tables, as to the comparative materials J and N, since martensite was formed during the patenting, the wire drawing disconnection occurred. As to the comparative material O, since the amount of V added was great and toughness was low, the disconnection occurred during the wire drawing process. Thus, it was impossible to produce the oil-tempered wire.

(Production Condition)

The austenitizing condition during the patenting: 900° C.×60 sec

The cooling rate after the austenitizing during the patenting: 15° C./sec

The isothermal transformation condition: 650° C.×60 sec

The heating rate before the quenching (room temperature to 600° C.): 20° C./sec

The heating rate before the quenching (600° C. to the keeping temperature): 10° C./sec

The quenching condition: radiation heating, 900° C., 90 sec

The tempering condition: 430° C.×30 sec→540° C.×30 sec (two steps)

The nitriding condition: 420° C., 450° C., 500° C.×1, 2, 4 hours (gas nitrocaburizing)

TABLE 10
420° C. × 1 hour

| Type | Lattice | Carbide | γ grain | | Tensile | Yield | Reduction | Fatigue |
|---|---|---|---|---|---|---|---|---|
| of | constant | size | size | Insoluble | strength | stress | of area | limit |
| steel | (\grave{Å}) | (nm) | (μm) | carbide | (MPa) | (MPa) | (%) | (MPa) |
| A | 2.872 | 20 | 4.8 | ◯ | 2125 | 1732 | 46 | 1210 |
| B | 2.87 | 25 | 4.9 | ◯ | 2125 | 1725 | 44 | 1205 |
| C | 2.873 | 19 | 4.5 | ◯ | 2140 | 1740 | 48 | 1220 |
| D | 2.872 | 20 | 4.5 | ◯ | 2084 | 1824 | 45 | 1215 |
| E | 2.871 | 21 | 4.5 | ◯ | 2132 | 1737 | 46 | 1210 |
| F | 2.872 | 21 | 4.5 | ◯ | 2138 | 1740 | 44 | 1205 |
| G | 2.872 | 21 | 4.5 | ◯ | 2135 | 1735 | 43 | 1210 |
| H | 2.872 | 22 | 4.2 | ◯ | 2133 | 1734 | 44 | 1210 |
| I | 2.871 | 22 | 4.1 | ◯ | 2134 | 1741 | 43 | 1210 |
| J | — | — | — | — | — | — | — | — |
| K | 2.865* | 26 | 4.5 | ◯ | 1943 | 1694 | 46 | 1110 |
| L | 2.891* | 42* | 4.6 | X | 1987 | 1657 | 31 | 1110 |
| M | 2.866* | 18 | 4.5 | ◯ | 1906 | 1678 | 47 | 1105 |
| N | — | — | — | — | — | — | — | — |
| O | — | — | — | — | — | — | — | — |

TABLE 11
420° C. × 2 hours

| Type | Lattice | Carbide | γ grain | | Tensile | Yield | Reduction | Fatigue |
|---|---|---|---|---|---|---|---|---|
| of | constant | size | size | Insoluble | strength | stress | of area | limit |
| steel | (\grave{Å}) | (nm) | (μm) | carbide | (MPa) | (MPa) | (%) | (MPa) |
| A | 2.873 | 21 | 4.8 | ◯ | 2083 | 1805 | 44 | 1215 |
| B | 2.871 | 25 | 4.9 | ◯ | 2076 | 1790 | 43 | 1210 |
| C | 2.874 | 20 | 4.5 | ◯ | 2097 | 1820 | 46 | 1230 |
| D | 2.872 | 21 | 4.5 | ◯ | 2054 | 1825 | 44 | 1220 |
| E | 2.872 | 22 | 4.5 | ◯ | 2088 | 1810 | 45 | 1215 |
| F | 2.873 | 22 | 4.5 | ◯ | 2091 | 1815 | 42 | 1215 |
| G | 2.872 | 21 | 4.5 | ◯ | 2090 | 1810 | 42 | 1220 |
| H | 2.872 | 22 | 4.2 | ◯ | 2087 | 1810 | 43 | 1220 |
| I | 2.872 | 23 | 4.1 | ◯ | 2084 | 1815 | 41 | 1215 |
| J | — | — | — | — | — | — | — | — |
| K | 2.866* | 27 | 4.5 | ◯ | 1938 | 1671 | 44 | 1115 |
| L | 2.891* | 42* | 4.6 | X | 1954 | 1637 | 29 | 1120 |
| M | 2.867* | 18 | 4.5 | ◯ | 1861 | 1642 | 45 | 1110 |
| N | — | — | — | — | — | — | — | — |
| O | — | — | — | — | — | — | — | — |

TABLE 12
420° C. × 4 hours

| | Lattice | Carbide | γ grain | | Tensile | Yield | Reduction | Fatigue |
|---|---|---|---|---|---|---|---|---|
| Type of | constant | size | size | Insoluble | strength | stress | of area | limit |
| steel | (\grave{Å}) | (nm) | (μm) | carbide | (MPa) | (MPa) | (%) | (MPa) |
| A | 2.873 | 22 | 4.8 | ◯ | 2021 | 1821 | 43 | 1220 |
| B | 2.871 | 26 | 4.9 | ◯ | 2014 | 1814 | 43 | 1215 |
| C | 2.874 | 22 | 4.5 | ◯ | 2042 | 1839 | 45 | 1240 |
| D | 2.872 | 22 | 4.5 | ◯ | 2023 | 1824 | 42 | 1225 |
| E | 2.872 | 23 | 4.5 | ◯ | 2031 | 1823 | 44 | 1220 |
| F | 2.873 | 23 | 4.5 | ◯ | 2039 | 1830 | 41 | 1220 |
| G | 2.872 | 23 | 4.5 | ◯ | 2034 | 1827 | 40 | 1220 |
| H | 2.872 | 24 | 4.2 | ◯ | 2031 | 1824 | 41 | 1225 |
| I | 2.872 | 23 | 4.1 | ◯ | 2033 | 1829 | 40 | 1225 |
| J | — | — | — | — | — | — | — | — |
| K | 2.866* | 28 | 4.5 | ◯ | 1902 | 1654 | 42 | 1110 |
| L | 2.891* | 44* | 4.6 | X | 1912 | 1612 | 27 | 1115 |
| M | 2.867* | 21 | 4.5 | ◯ | 1827 | 1606 | 44 | 1105 |
| N | — | — | — | — | — | — | — | — |
| O | — | — | — | — | — | — | — | — |

TABLE 13
450° C. × 1 hour

| | Lattice | Carbide | γ grain | | Tensile | Yield | Reduction | Fatigue |
|---|---|---|---|---|---|---|---|---|
| Type of | constant | size | size | Insoluble | strength | stress | of area | limit |
| steel | (\grave{Å}) | (nm) | (μm) | carbide | (MPa) | (MPa) | (%) | (MPa) |
| A | 2.884 | 22 | 4.8 | ◯ | 2009 | 1728 | 43 | 1215 |
| B | 2.882 | 27 | 4.9 | ◯ | 2004 | 1721 | 42 | 1215 |
| C | 2.885 | 20 | 4.5 | ◯ | 2023 | 1748 | 44 | 1235 |
| D | 2.883 | 22 | 4.5 | ◯ | 2000 | 1795 | 43 | 1235 |
| E | 2.884 | 24 | 4.5 | ◯ | 2004 | 1730 | 45 | 1215 |
| F | 2.883 | 23 | 4.5 | ◯ | 2001 | 1735 | 43 | 1220 |
| G | 2.883 | 24 | 4.5 | ◯ | 1998 | 1733 | 42 | 1220 |
| H | 2.883 | 24 | 4.2 | ◯ | 2003 | 1731 | 42 | 1220 |
| I | 2.883 | 24 | 4.1 | ◯ | 2002 | 1728 | 42 | 1215 |
| J | — | — | — | — | — | — | — | — |
| K | 2.866* | 31 | 4.5 | ◯ | 1934 | 1684 | 43 | 1115 |
| L | 2.892* | 46* | 4.6 | X | 1967 | 1649 | 29 | 1115 |
| M | 2.867* | 20 | 4.5 | ◯ | 1865 | 1639 | 45 | 1110 |
| N | — | — | — | — | | — | — | — |
| O | — | — | — | — | | — | — | — |

TABLE 14
450° C. × 2 hours

| | Lattice | Carbide | γ grain | | Tensile | Yield | Reduction | Fatigue |
|---|---|---|---|---|---|---|---|---|
| Type of | constant | size | size | Insoluble | strength | stress | of area | limit |
| steel | (\grave{Å}) | (nm) | (μm) | carbide | (MPa) | (MPa) | (%) | (MPa) |
| A | 2.885 | 23 | 4.8 | ◯ | 1981 | 1773 | 42 | 1235 |
| B | 2.883 | 28 | 4.9 | ◯ | 1974 | 1770 | 41 | 1230 |
| C | 2.886 | 22 | 4.5 | ◯ | 2001 | 1795 | 43 | 1245 |
| D | 2.884 | 23 | 4.5 | ◯ | 1984 | 1794 | 42 | 1240 |
| E | 2.885 | 24 | 4.5 | ◯ | 1986 | 1784 | 44 | 1235 |
| F | 2.884 | 24 | 4.5 | ◯ | 1984 | 1788 | 41 | 1235 |
| G | 2.885 | 25 | 4.5 | ◯ | 1979 | 1783 | 40 | 1230 |
| H | 2.884 | 24 | 4.2 | ◯ | 1977 | 1785 | 41 | 1235 |
| I | 2.885 | 26 | 4.1 | ◯ | 1974 | 1780 | 40 | 1230 |
| J | — | — | — | — | — | — | — | — |
| K | 2.868* | 32 | 4.5 | ◯ | 1897 | 1652 | 41 | 1125 |
| L | 2.893* | 48* | 4.6 | X | 1943 | 1628 | 28 | 1130 |
| M | 2.868* | 22 | 4.5 | ◯ | 1839 | 1621 | 43 | 1125 |
| N | — | — | — | — | — | — | — | — |
| O | — | — | — | — | — | — | — | — |

TABLE 15
450° C. × 4 hours

| | Lattice | Carbide | γ grain | | Tensile | Yield | Reduction | Fatigue |
|---|---|---|---|---|---|---|---|---|
| Type of | constant | size | size | Insoluble | strength | stress | of area | limit |
| steel | (\grave{Å}) | (nm) | (μm) | carbide | (MPa) | (MPa) | (%) | (MPa) |
| A | 2.886 | 24 | 4.8 | ◯ | 1932 | 1806 | 41 | 1240 |
| B | 2.884 | 30 | 4.9 | ◯ | 1922 | 1791 | 41 | 1235 |
| C | 2.887 | 23 | 4.5 | ◯ | 1951 | 1829 | 40 | 1255 |
| D | 2.885 | 25 | 4.5 | ◯ | 1933 | 1795 | 40 | 1240 |
| E | 2.886 | 25 | 4.5 | ◯ | 1941 | 1808 | 42 | 1235 |
| F | 2.885 | 25 | 4.5 | ◯ | 1939 | 1810 | 39 | 1235 |
| G | 2.886 | 26 | 4.5 | ◯ | 1937 | 1815 | 39 | 1230 |
| H | 2.887 | 25 | 4.2 | ◯ | 1938 | 1809 | 39 | 1235 |
| I | 2.887 | 27 | 4.1 | ◯ | 1929 | 1802 | 38 | 1235 |
| J | — | — | — | — | — | | — | — |
| K | 2.869* | 33 | 4.5 | ◯ | 1846 | 1612 | 38 | 1120 |
| L | 2.894* | 49* | 4.6 | X | 1917 | 1603 | 25 | 1125 |
| M | 2.868* | 24 | 4.5 | ◯ | 1798 | 1582 | 41 | 1125 |
| N | — | — | — | — | | — | — | — |
| O | — | — | — | — | | — | — | |

TABLE 16
500° C. × 1 hour

| | Lattice | Carbide | γ grain | | Tensile | Yield | Reduction | Fatigue |
|---|---|---|---|---|---|---|---|---|
| Type of | constant | size | size | Insoluble | strength | stress | of area | limit |
| steel | (\grave{Å}) | (nm) | (μm) | carbide | (MPa) | (MPa) | (%) | (MPa) |
| A | 2.888 | 27 | 4.8 | ◯ | 1938 | 1710 | 42 | 1230 |
| B | 2.887 | 31 | 4.9 | ◯ | 1931 | 1703 | 42 | 1230 |
| C | 2.888 | 24 | 4.5 | ◯ | 1954 | 1725 | 43 | 1235 |
| D | 2.888 | 28 | 4.5 | ◯ | 1941 | 1765 | 43 | 1225 |
| E | 2.889 | 27 | 4.5 | ◯ | 1928 | 1715 | 44 | 1230 |
| F | 2.886 | 25 | 4.5 | ◯ | 1936 | 1712 | 40 | 1230 |
| G | 2.887 | 27 | 4.5 | ◯ | 1945 | 1719 | 40 | 1230 |
| H | 2.887 | 25 | 4.2 | ◯ | 1943 | 1721 | 41 | 1225 |
| I | 2.888 | 26 | 4.1 | ◯ | 1928 | 1719 | 41 | 1225 |
| J | — | — | — | — | — | — | — | — |
| K | 2.868* | 42* | 4.5 | ◯ | 1879 | 1638 | 41 | 1110 |
| L | 2.892* | 51* | 4.6 | X | 1954 | 1628 | 27 | 1110 |
| M | 2.868* | 30 | 4.5 | ◯ | 1821 | 1575 | 43 | 1105 |
| N | — | — | — | — | | — | — | — |
| O | — | — | — | — | | — | — | — |

TABLE 17
500° C. × 2 hours

| | Lattice | Carbide | γ grain | | Tensile | Yield | Reduction | Fatigue |
|---|---|---|---|---|---|---|---|---|
| Type of | constant | size | size | Insoluble | strength | stress | of area | limit |
| steel | (\grave{Å}) | (nm) | (μm) | carbide | (MPa) | (MPa) | (%) | (MPa) |
| A | 2.889 | 28 | 4.8 | ◯ | 1898 | 1724 | 40 | 1240 |
| B | 2.887 | 32 | 4.9 | ◯ | 1888 | 1712 | 39 | 1235 |
| C | 2.890 | 25 | 4.5 | ◯ | 1933 | 1738 | 41 | 1245 |
| D | 2.889 | 28 | 4.5 | ◯ | 1895 | 1767 | 41 | 1230 |
| E | 2.889 | 27 | 4.5 | ◯ | 1905 | 1732 | 42 | 1235 |
| F | 2.887 | 26 | 4.5 | ◯ | 1910 | 1735 | 39 | 1235 |
| G | 2.888 | 28 | 4.5 | ◯ | 1912 | 1733 | 38 | 1230 |
| H | 2.887 | 26 | 4.2 | ◯ | 1908 | 1738 | 39 | 1235 |
| I | 2.889 | 27 | 4.1 | ◯ | 1901 | 1730 | 39 | 1235 |
| J | — | — | — | — | — | — | — | — |
| K | 2.869* | 43* | 4.5 | ◯ | 1854 | 1618 | 40 | 1120 |
| L | 2.894* | 53* | 4.6 | X | 1923 | 1597 | 26 | 1125 |
| M | 2.869* | 31 | 4.5 | ◯ | 1764 | 1545 | 41 | 1125 |
| N | — | — | — | — | — | — | — | — |
| O | — | — | — | — | — | — | — | — |

TABLE 18
500° C. × 4 hours

| | Lattice | Carbide | γ grain | | Tensile | Yield | Reduction | Fatigue |
|---|---|---|---|---|---|---|---|---|
| Type of | constant | size | size | Insoluble | strength | stress | of area | limit |
| steel | (\grave{Å}) | (nm) | (μm) | carbide | (MPa) | (MPa) | (%) | (MPa) |
| A | 2.890 | 29 | 4.8 | ◯ | 1885 | 1742 | 38 | 1240 |
| B | 2.888 | 34 | 4.9 | ◯ | 1875 | 1738 | 37 | 1235 |
| C | 2.890 | 26 | 4.5 | ◯ | 1906 | 1763 | 38 | 1250 |
| D | 2.889 | 30 | 4.5 | ◯ | 1882 | 1767 | 38 | 1235 |
| E | 2.890 | 29 | 4.5 | ◯ | 1892 | 1748 | 40 | 1230 |
| F | 2.888 | 27 | 4.5 | ◯ | 1895 | 1742 | 37 | 1235 |
| G | 2.887 | 29 | 4.5 | ◯ | 1896 | 1747 | 37 | 1235 |
| H | 2.889 | 27 | 4.2 | ◯ | 1889 | 1751 | 37 | 1230 |
| I | 2.890 | 29 | 4.1 | ◯ | 1891 | 1749 | 38 | 1230 |
| J | — | — | — | — | — | — | — | — |
| K | 2.869* | 45* | 4.5 | ◯ | 1804 | 1587 | 38 | 1120 |
| L | 2.894* | 54* | 4.6 | X | 1864 | 1563 | 24 | 1120 |
| M | 2.869* | 33 | 4.5 | ◯ | 1710 | 1505 | 39 | 1115 |
| N | — | — | — | — | — | — | — | — |
| O | — | — | — | — | — | — | — | — |

(Result)

All of the materials A to I according to the invention satisfied the set values of the lattice constant after the nitriding, the size of carbide formed after the tempering process, the grain size of austenite, yield stress after the heat treatment for the nitriding, and the reduction of area. Additionally, the fatigue limit was 1150 MPa or more that was the set value.

Meanwhile, the comparative materials K and M had the low lattice constant after the nitriding and the low yield stress after the heat treatment for the nitriding. Since the comparative material L had the high lattice constant after the nitriding and insoluble carbide, the fatigue limit was reduced.

### Experimental Example 2-2

### The Patenting Condition and the Heating Rate 2 Before the Quenching

The cooling condition after the austenitizing during the patenting, the heating rate before the quenching, and the quenching tempering condition were changed for the material A according to the invention and the comparative material K of Table 1 as shown in Table 19, and the oil-tempered wire was produced. Next, the nitriding treatment was performed at 450° C. for 2 hours. Subsequently, shot peening (0.2 SB, 20 minutes) and the stress relieving annealing were performed (230° C.×30 minutes), and the Nakamura-type rotation bending fatigue test were conducted. The results are described in Tables 20 and 21. In the Tables, conditions other than the patenting cooling rate were not described in the production conditions 4, 10, and 14. The reason is that martensite was generated during the patenting to obstruct desirable perlite transformation, causing wire disconnection during the wire drawing. Further, “*” denotes that it is outside the scope of the present invention. The keeping time at the tempering temperature was as follows. The first step: 60 sec, and the second step: 30 sec respectively.

TABLE 19

| | | Heating | | | |
|---|---|---|---|---|---|
| | | rate | Heating | | |
| | | (room | rate | | |
| | Patenting | temperature | (600° C. to keeping | | |
| Production | cooling rate | to 600° C.) | temperature) | | Tempering |
| condition | (° C./sec) | (° C./sec) | (° C./sec) | Quenching condition | condition |
| 1 | 18 | 40 | 10 | radiation heating: | 450° C. → 550° C. |
| | | | | 900° C.-90 sec | (second step) |
| 2 | 12 | 25 | 20 | radiation heating: | 450° C. → 550° C. |
| | | | | 900° C.-90 sec | second step |
| 3 | 5* | 25 | 20 | radiation heating: | 420° C. → 580° C. |
| | | | | 940° C.-120 sec | (second step) |
| 4 | 50* | — | — | — | — |
| 5 | 12 | 10* | 20 | radiation heating: | 450° C. (— step) |
| | | | | 870° C.-45 sec | |
| 6 | 12 | 80* | 20 | radiation heating: | 540° C. (first |
| | | | | 870° C.-130 sec | step) |
| 7 | 12 | 25 | 2* | radiation heating: | 450° C. → 470° C. |
| | | | | 940° C.-40 sec | (second step) |
| 8 | 12 | 25 | 40* | radiation heating: | 450° C. → 550° C. |
| | | | | 900° C.-40 sec | (second step) |
| 9 | 5* | 10* | 20 | radiation heating: | 450° C. → 550° C. |
| | | | | 900° C.-90 sec | (second step) |
| 10 | 50* | — | — | — | — |
| 11 | 12 | 10* | 2* | radiation heating: | 450° C. → 550° C. |
| | | | | 900° C.-90 sec | (second step) |
| 12 | 12 | 300* | 300* | high-frequency | 450° C. → 550° C. |
| | | | | induction heating: | (second step) |
| | | | | 1000° C.-2 sec | |
| 13 | 5* | 25 | 2* | radiation heating: | 450° C. → 550° C. |
| | | | | 900° C.-90 sec | (second step) |
| 14 | 50* | — | — | — | — |
| 15 | 12 | 25 | 2* | radiation heating: | 450° C. → 550° C. |
| | | | | 970° C.-20 sec * | (second step) |
| 16 | 12 | 10* | 20 | radiation heating: | 450° C. → 550° C. |
| | | | | 970° C.-20 sec * | (second step) |
| 17 | 5* | 25 | 20 | radiation heating: | 450° C. → 550° C. |
| | | | | 970° C.-20 sec * | (second step) |
| 18 | 5* | 10* | 2* | radiation heating: | 450° C. → 550° C. |
| | | | | 900° C.-90 sec | (second step) |
| 19 | 18 | 40 | 10 | radiation heating: | 450° C. → 550° C. |
| | | | | 830° C.-170 sec * | (second step) |
| 20 | 12 | 25 | 20 | radiation heating: | 450° C. → 550° C. |
| | | | | 970° C.-20 sec * | (second step) |
| 21 | 5* | 10* | 2* | radiation heating: | 450° C. → 550° C. |
| | | | | 980° C.-140 sec * | (second step) |
| 22 | 5* | 300* | 300* | high-frequency | 450° C. → 550° C. |
| | | | | induction heating: | (second step) |
| | | | | 860° C. → 0.5 sec * | |

TABLE 20
Material A according to the invention

| | | | γ | | | | | |
|---|---|---|---|---|---|---|---|---|
| | Lattice | Carbide | grain | | Tensile | Yield | Reduction | Fatigue |
| Production | constant | size | size | Insoluble | strength | stress | of area | limit |
| condition | (\grave{Å}) | (nm) | (μm) | carbide | (MPa) | (MPa) | (%) | (MPa) |
| 1 | 2.885 | 26 | 4.4 | ◯ | 1982 | 1778 | 43 | 1240 |
| 2 | 2.885 | 26 | 4.2 | ◯ | 1978 | 1781 | 43 | 1245 |
| 3 | 2.885 | 28 | 4.4 | ◯ | 1975 | 1769 | 42 | 1235 |
| 4 | — | — | — | — | — | — | — | — |
| 5 | 2.885 | 26 | 4.3 | ◯ | 1986 | 1781 | 43 | 1230 |
| 6 | 2.885 | 28 | 4.3 | ◯ | 1982 | 1775 | 44 | 1235 |
| 7 | 2.885 | 25 | 5.1 | ◯ | 1978 | 1769 | 42 | 1235 |
| 8 | 2.885 | 26 | 4.6 | ◯ | 1977 | 1774 | 44 | 1230 |
| 9 | 2.885 | 26 | 4.2 | ◯ | 1976 | 1782 | 45 | 1235 |
| 10 | — | — | — | — | — | — | — | — |
| 11 | 2.885 | 26 | 4.9 | ◯ | 1978 | 1772 | 43 | 1230 |
| 12 | 2.885 | 25 | 3.8 | ◯ | 1985 | 1792 | 44 | 1235 |
| 13 | 2.885 | 26 | 4.7 | ◯ | 1983 | 1776 | 42 | 1225 |
| 14 | — | — | — | — | — | — | — | — |
| 15 | 2.885 | 26 | 4.8 | Δ | 1981 | 1775 | 39 | 1190 |
| 16 | 2.885 | 25 | 4.6 | Δ | 1979 | 1773 | 40 | 1190 |
| 17 | 2.885 | 26 | 4.6 | Δ | 1977 | 1781 | 38 | 1195 |
| 18 | 2.885 | 26 | 4.5 | Δ | 1979 | 1782 | 39 | 1195 |
| 19 | 2.885 | 26 | 3.7 | Δ | 1976 | 1761 | 40 | 1195 |
| 20 | 2.885 | 27 | 4.5 | Δ | 1978 | 1758 | 39 | 1190 |
| 21 | 2.885 | 26 | 11.4 | Δ | 1981 | 1688 | 38 | 1130 |
| 22 | 2.885 | 26 | 2.7 | X | 1977 | 1654 | 24 | 1125 |

TABLE 21
Comparative material K

| | Lattice | Carbide | γ grain | | Tensile | Yield | Reduction | Fatigue |
|---|---|---|---|---|---|---|---|---|
| Production | constant | size | size | Insoluble | strength | stress | of area | limit |
| condition | (\grave{Å}) | (nm) | (μm) | carbide | (MPa) | (MPa) | (%) | (MPa) |
| 1 | 2.868 | 32 | 4.8 | ◯ | 1895 | 1652 | 42 | 1125 |
| 2 | 2.868 | 31 | 4.6 | ◯ | 1892 | 1661 | 42 | 1120 |
| 3 | 2.868 | 32 | 4.7 | ◯ | 1887 | 1654 | 42 | 1116 |
| 4 | — | — | — | — | — | — | — | — |
| 5 | 2.868 | 31 | 4.5 | ◯ | 1893 | 1653 | 41 | 1110 |
| 6 | 2.868 | 33 | 4.4 | ◯ | 1897 | 1658 | 40 | 1110 |
| 7 | 2.868 | 30 | 5.3 | ◯ | 1889 | 1645 | 42 | 1105 |
| 8 | 2.868 | 30 | 5 | ◯ | 1892 | 1647 | 41 | 1105 |
| 9 | 2.868 | 31 | 4.5 | ◯ | 1887 | 1652 | 41 | 1110 |
| 10 | — | — | — | — | — | — | — | — |
| 11 | 2.868 | 32 | 5.1 | ◯ | 1889 | 1646 | 43 | 1110 |
| 12 | 2.868 | 31 | 4.1 | ◯ | 1896 | 1667 | 42 | 1115 |
| 13 | 2.868 | 32 | 5 | ◯ | 1892 | 1654 | 41 | 1105 |
| 14 | — | — | — | — | — | — | — | — |
| 15 | 2.868 | 30 | 5.0 | Δ | 1882 | 1615 | 38 | 975 |
| 16 | 2.868 | 31 | 4.8 | Δ | 1884 | 1622 | 37 | 975 |
| 17 | 2.868 | 30 | 4.8 | Δ | 1881 | 1627 | 37 | 980 |
| 18 | 2.868 | 32 | 4.7 | Δ | 1880 | 1632 | 38 | 980 |
| 19 | 2.868 | 32 | 3.9 | Δ | 1884 | 1625 | 38 | 980 |
| 20 | 2.868 | 34 | 4.8 | Δ | 1882 | 1613 | 36 | 985 |
| 21 | 2.868 | 33 | 12.1 | Δ | 1878 | 1598 | 36 | 945 |
| 22 | 2.868 | 33 | 3.1 | X | 1884 | 1576 | 23 | 930 |

From Tables 20 and 21, it can be apparently seen that the material A according to the invention satisfied the set values of the lattice constant after the nitriding, the size of carbide formed after the tempering process, yield stress after the heat treatment for the nitriding, and the reduction of area in the production conditions 1 to 20. Additionally, the fatigue limit was high.

In the production condition 21, the γ grain size was increased, thus reducing yield stress. In the production condition 22, the insoluble carbide remained and the average diameter of the carbide was more than 200 nm. Accordingly, toughness of the matrix was reduced, thus reducing fatigue limit.

The comparative material K had the low lattice constant after the nitriding for all conditions. In the production condition 21, the γ grain size was increased, thus reducing yield stress. In the production condition 22, the insoluble carbide remained and the average diameter of the carbide was more than 200 nm. Accordingly, toughness of the matrix was reduced, thus reducing fatigue limit.

While description has been made in connection with specific examples of the present invention, those skilled in the art will understand that various changes and modification may be made therein without departing from the true spirit and scope of the present invention.

The present application claims priority from Japanese Patent Application No. 2005-228859 filed on Aug. 5, 2005 and Japanese Patent Application No. 2005-248468 filed on Aug. 29, 2005, the contents of which are incorporated herein by reference.

### INDUSTRIAL APPLICABILITY

An oil-tempered wire according to the invention may be used to produce a spring that requires fatigue strength and toughness.

Furthermore, a method of producing the oil-tempered wire according to the invention may be applied to produce the oil-tempered wire that requires fatigue strength and toughness.

Additionally, a spring according to the invention may be used for a valve spring for motor engine or a spring for transmission.

### BRIEF DESCRIPTION OF THE DRAWINGS

FIG. 1 is a view explaining a temperature profile of a process of producing a spring using an oil-tempered wire.

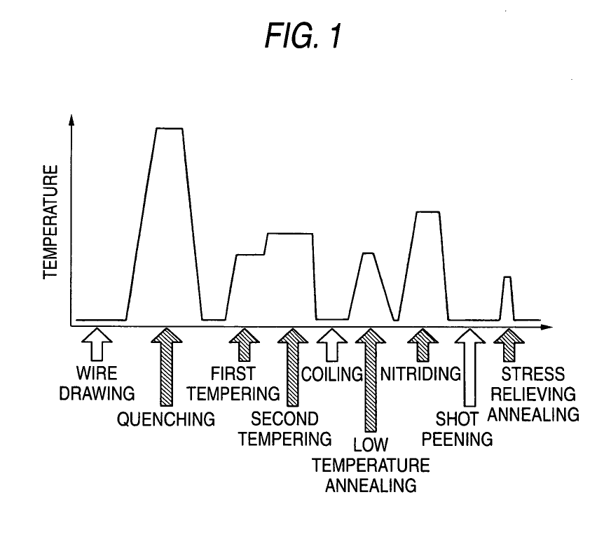

FIG. 2 is a graph showing a correlation between the austenitizing condition of material according to the invention according to experimental example 1-2 and the presence of insoluble carbides.

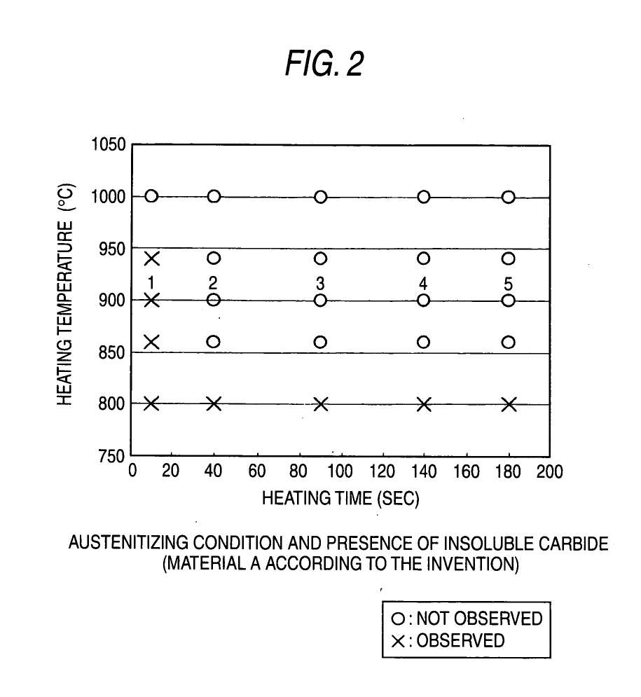

FIG. 3 is a graph showing a correlation between the austenitizing condition of comparative material according to experimental example 1-2 and the presence of insoluble carbides.

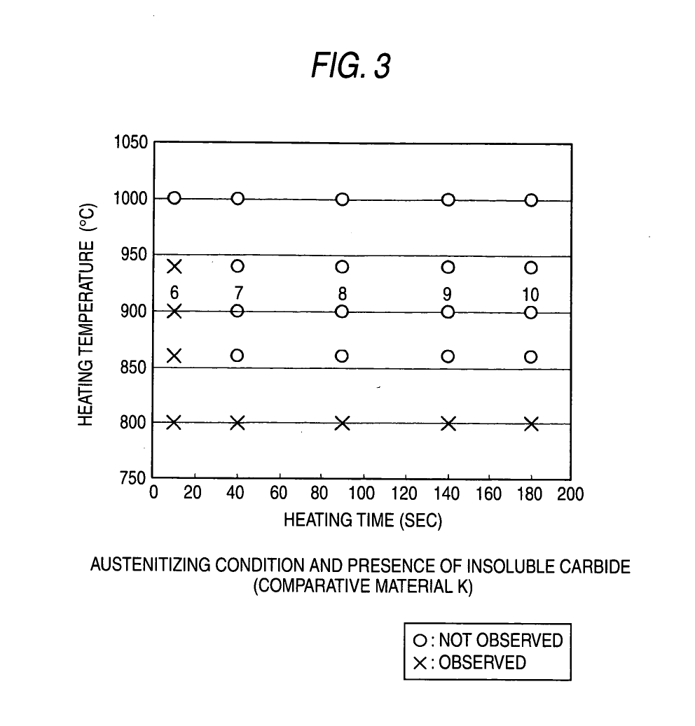

FIG. 4 is a graph showing a correlation between the austenitizing condition of material according to the invention according to experimental example 1-2 and a γ grain size.

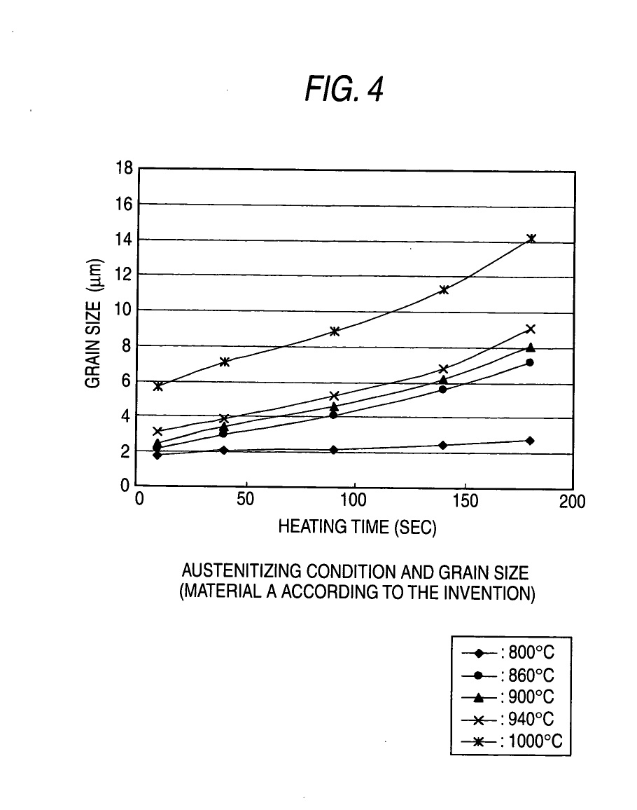

FIG. 5 is a graph showing a correlation between the austenitizing condition of comparative material according to experimental example 1-2 and the γ grain size.

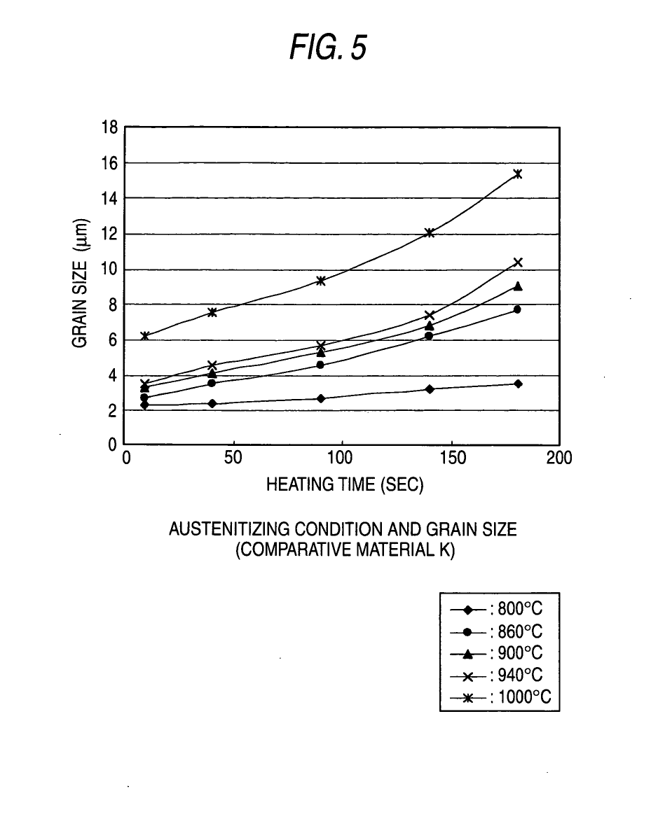

FIG. 6 (A) is a microscopic picture of the structure of the sample No. 1, and (B) is a microscopic picture of the structure of the sample No. 2.

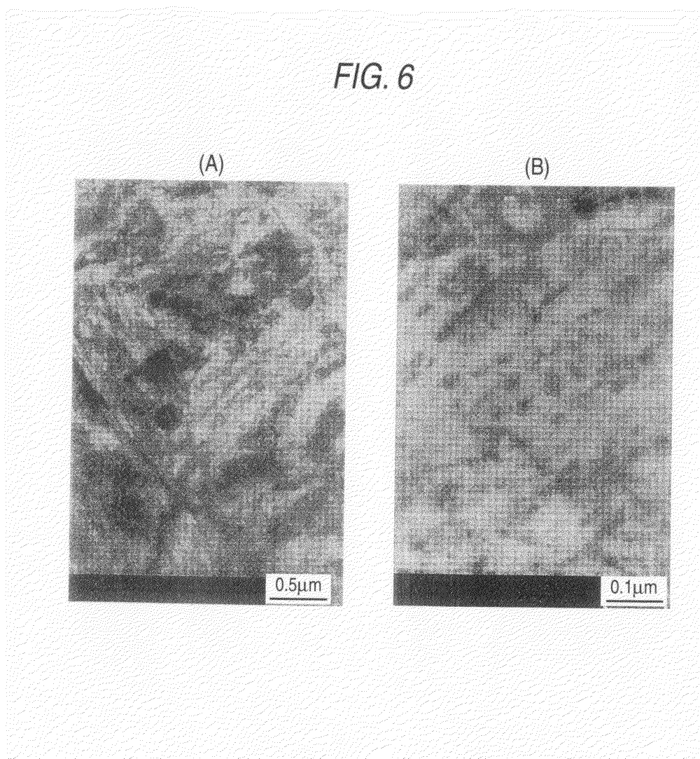

FIG. 7 is a graph showing a correlation between the austenitizing condition of material according to the invention according to experimental example 1-3 and the presence of insoluble carbides.

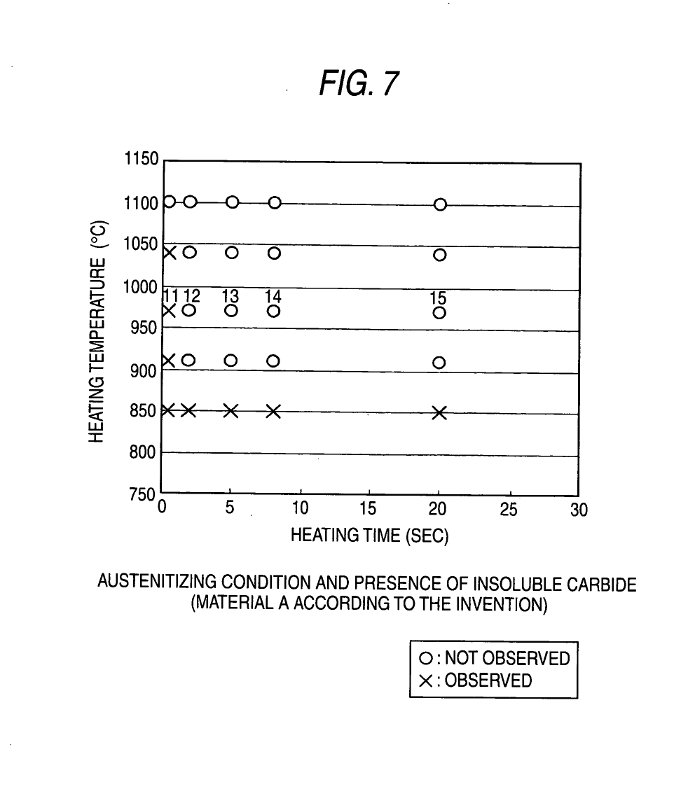

FIG. 8 is a graph showing a correlation between the austenitizing condition of comparative material according to experimental example 1-3 and the presence of insoluble carbides.

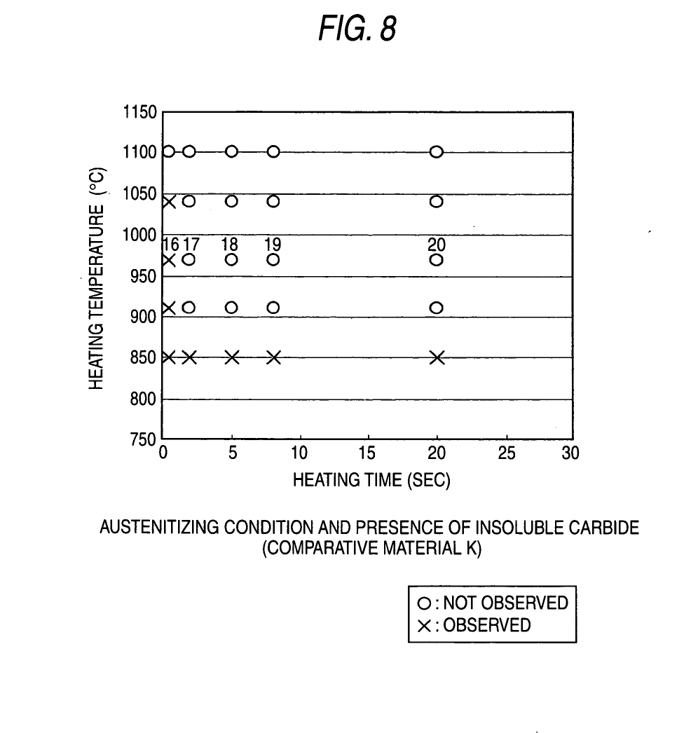

FIG. 9 is a graph showing a correlation between the austenitizing condition of material according to the invention according to experimental example 1-3 and a γ grain size.

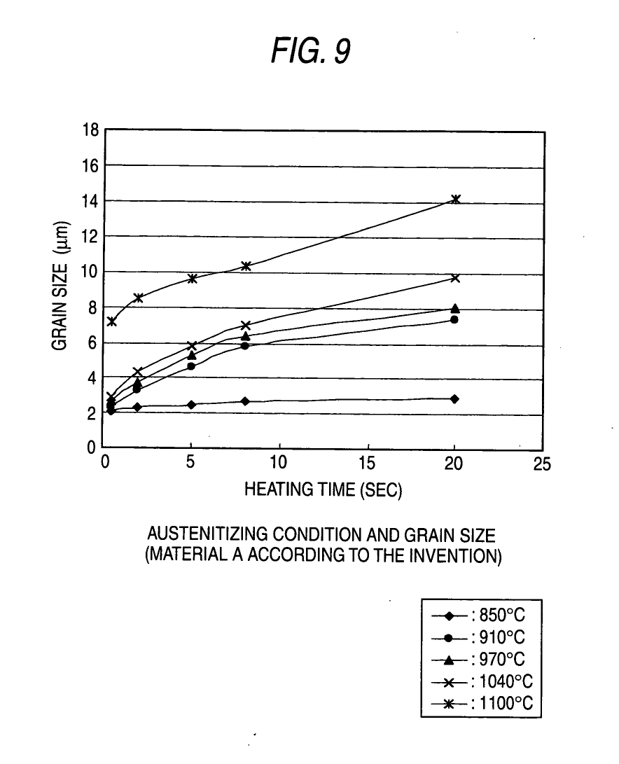

FIG. 10 is a graph showing a correlation between the austenitizing condition of comparative material according to experimental example 1-3 and the γ grain size.

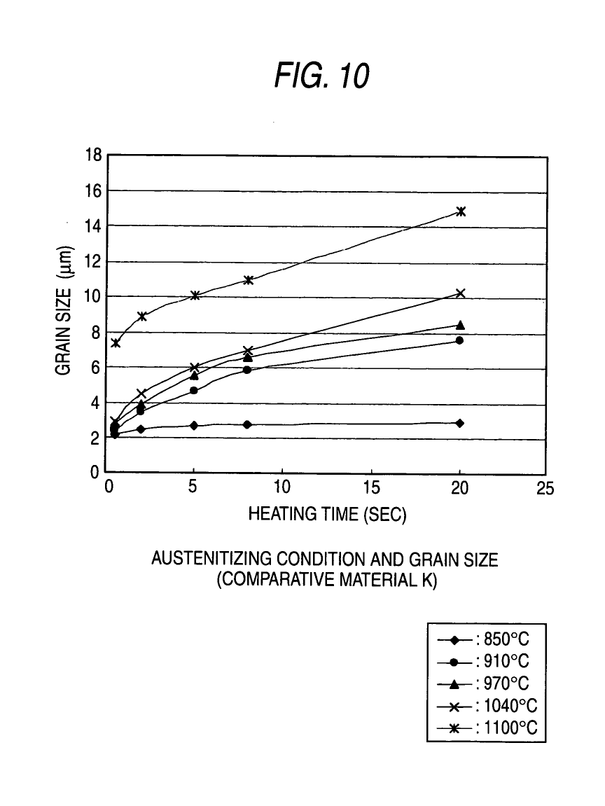

FIG. 11 is a graph showing a correlation between the tempering condition of material according to the invention according to experimental example 1-4-1 and the reduction of area.

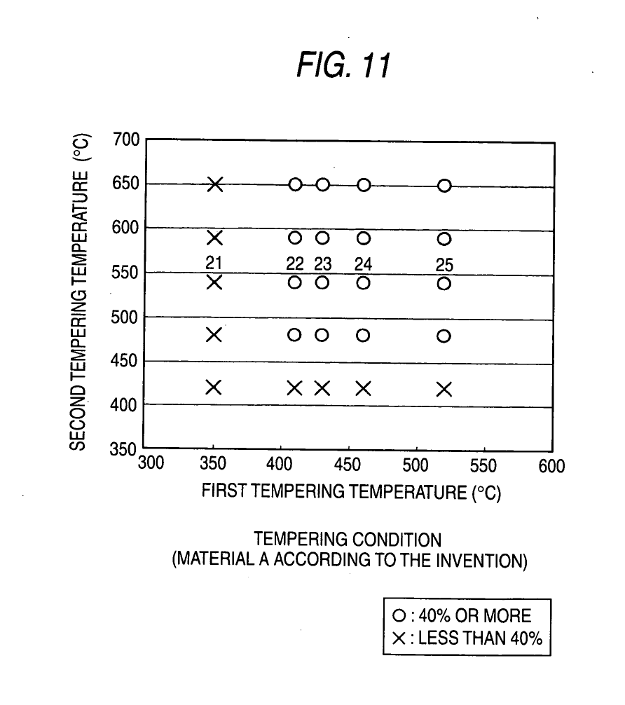

FIG. 12 is a graph showing a correlation between the tempering condition of comparative material according to experimental example 1-4-1 and the reduction of area.

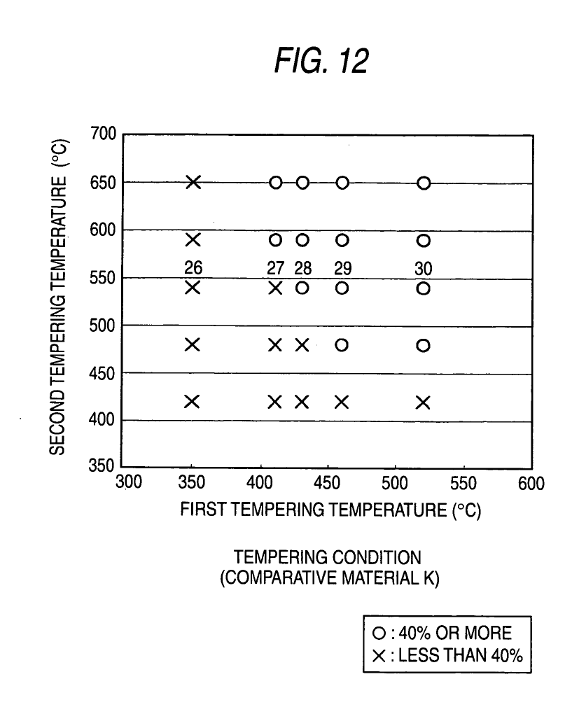

FIG. 13 is a graph showing a correlation between the tempering condition of material according to the invention according to experimental example 1-4-1 and the size of carbide.

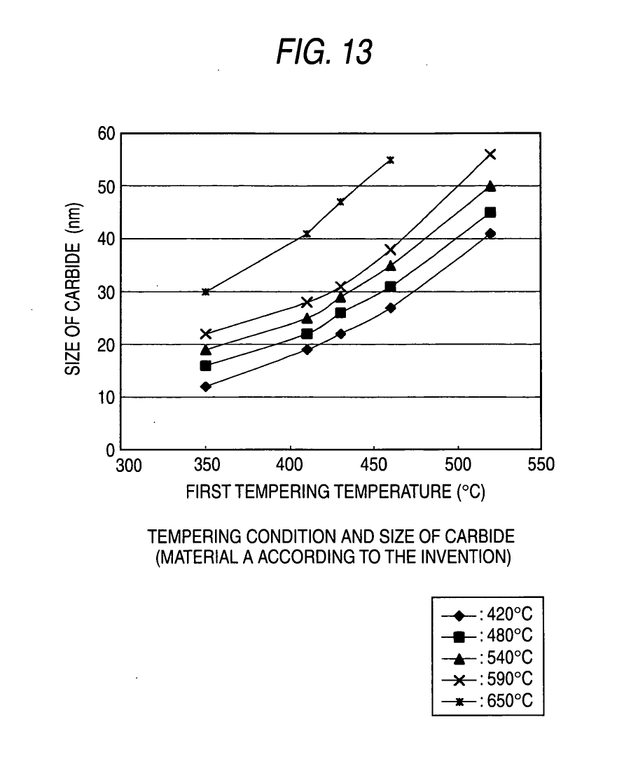

FIG. 14 is a graph showing a correlation between the tempering condition of comparative material according to experimental example 1-4-1 and the size of carbide.

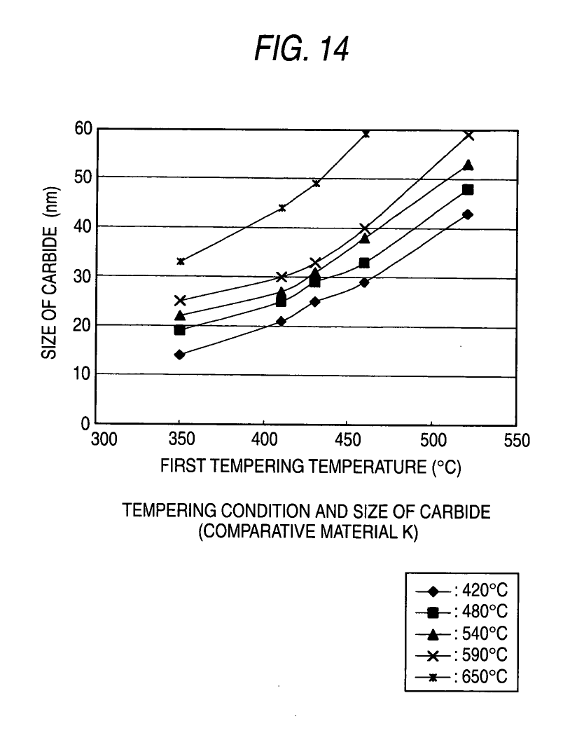

FIG. 15 is a graph showing a correlation between the tempering condition of material according to the invention according to experimental example 1-5 and the reduction of area.

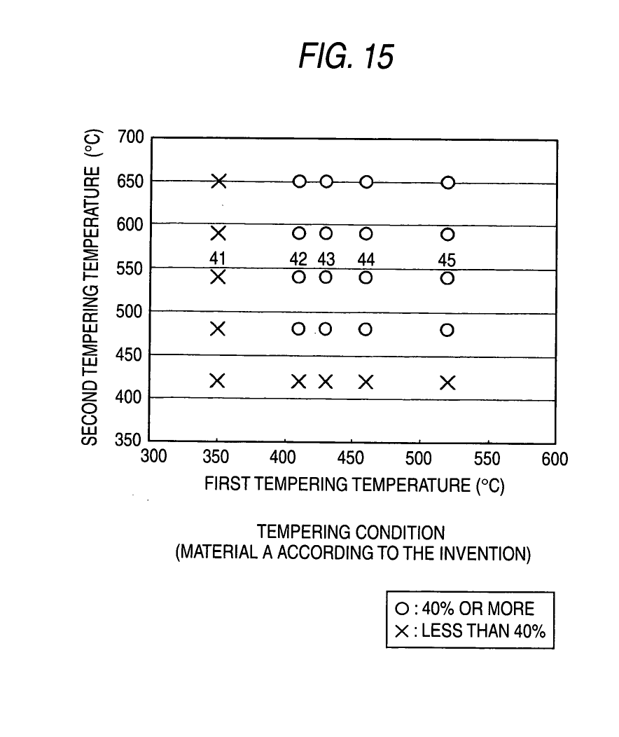

FIG. 16 is a graph showing a correlation between the tempering condition of comparative material according to experimental example 1-5 and the reduction of area.

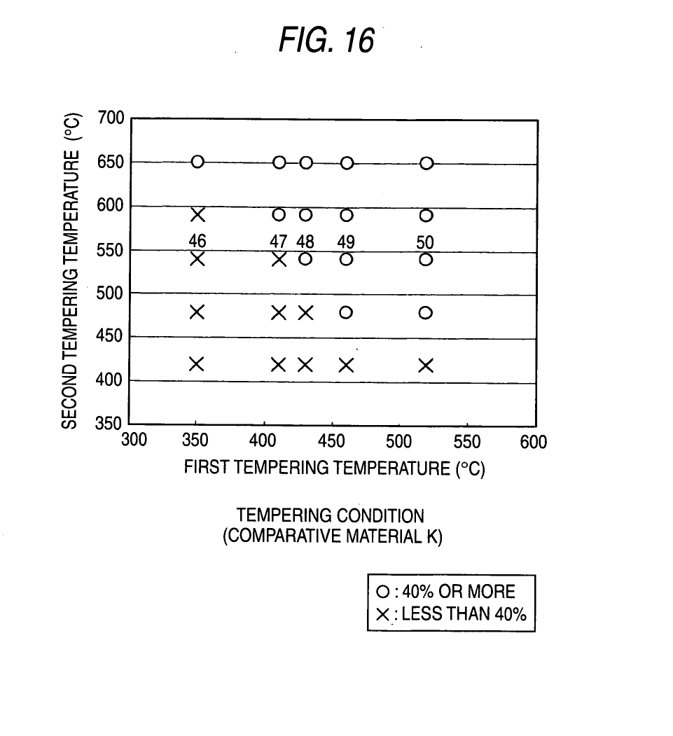

FIG. 17 is a graph showing a correlation between the tempering condition of material according to the invention according to experimental example 1-5 and the size of carbide.

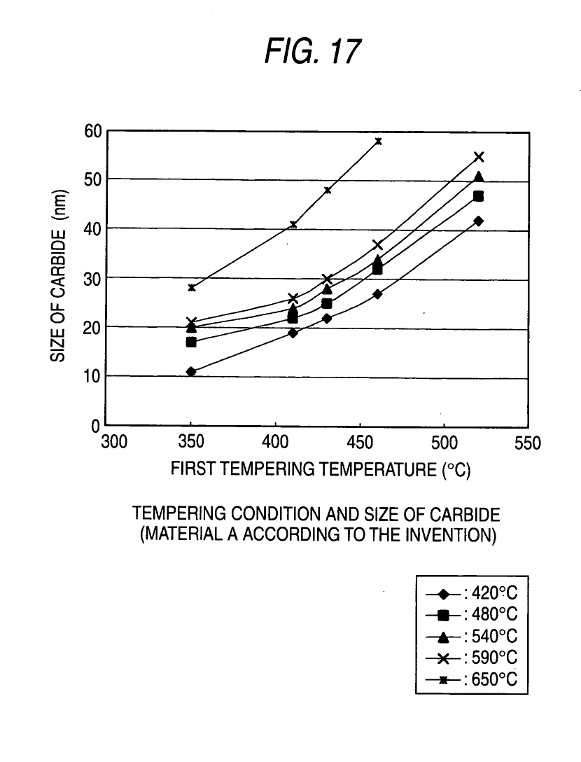

FIG. 18 is a graph showing a correlation between the tempering condition of comparative material according to experimental example 1-5 and the size of carbide.

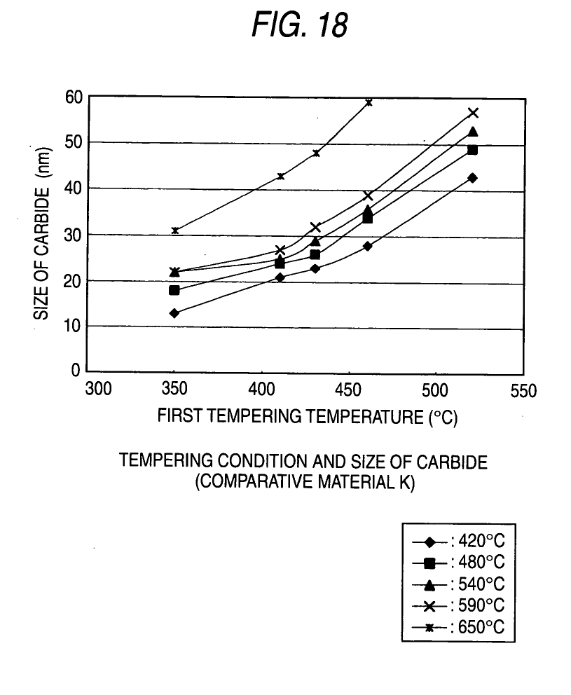

FIG. 19 is a view of explaining the temperature profile of the process of producing the oil-tempered wire.

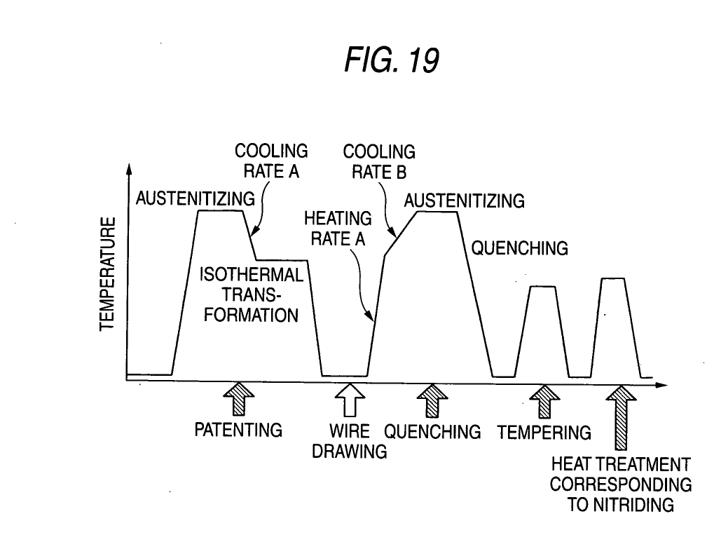

1. An oil-tempered wire comprising a tempered martensite structure,
wherein a lattice constant of a nitride layer formed on a surface of the wire is 2.870 Å to 2.890 Å when the oil-tempered wire is nitrided.

2. The oil-tempered wire according to claim 1, wherein a nitriding treatment is performed at 420° C. to 500° C.

3. The oil-tempered wire according to claim 1, wherein the lattice constant is 2.881 Å to 2.890 Å.

4. The oil-tempered wire according to claim 3, wherein a nitriding treatment is performed at 450° C. to 500° C.

5. The oil-tempered wire according to claim 1, wherein an average grain size of spherical carbide formed in the wire after the nitriding treatment and tempering is 40 nm or less.

6. An oil-tempered wire comprising a tempered martensite structure,
wherein a yield stress after heating for 2 hours at 420° C. to 500° C. and a yield stress after heating for 4 hours at the same temperature are higher than a yield stress after heating for 1 hour at the same temperature.

7. The oil-tempered wire according to claim 6, wherein the yield stress after the heating for 2 hours is higher than the yield stress after the heating for 1 hour at 420° C. to 500° C., and the yield stress after the heating for 4 hours at the same temperature is higher than the yield stress after the heating for 2 hours at the same temperature.

8. The oil-tempered wire according to claim 6, wherein a tensile strength after the heating for 2 hours at 420° C. to 500° C. is lower than a tensile strength after the heating for 1 hour at the same temperature, and a tensile strength after the heating for 4 hours at the same temperature is lower than the tensile strength after the heating for 2 hours at the same temperature.

9. The oil-tempered wire according to claim 6, wherein the tensile strength after quenching tempering is 2000 MPa or more, and the yield stress after the heating at 420° C. to 500° C. for 2 hours is 1700 MPa or more.

10. The oil-tempered wire according to claim 9, wherein the yield stress after the heating at 420° C. to 450° C. for 2 hours is 1750 MPa or more.

11. The oil-tempered wire according to claim 6, wherein a reduction of area after the heating at 420° C. to 500° C. for 2 hours is 35% or more.

12. The oil-tempered wire according to claim 1, containing:
in terms of mass %,
0.50 to 0.75% of C;
1.50 to 2.50% of Si;
0.20 to 1.00% of Mn;
0.70 to 2.20% of Cr;
0.05 to 0.50% of V, and
a balance including Fe and inevitable impurities.

13. The oil-tempered wire according to claim 12, further containing 0.02 to 1.00% of Co in terms of mass %.

14. The oil-tempered wire according to claim 12, further containing, in terms of mass %, one or more selected from the group consisting of 0.1 to 1.0% of Ni, 0.05 to 0.50% of Mo, 0.05 to 0.15% of W, 0.05 to 0.15% of Nb, and 0.01 to 0.20% of Ti.

15. A spring that is formed by spring processing an oil-tempered wire comprising a tempered martensite structure, the spring comprising:
a nitride layer formed on a surface of the spring by a nitriding treatment,
wherein a lattice constant of the nitride layer is 2.870 Å to 2.890 Å.

16. The spring according to claim 15, wherein the nitriding treatment is performed at 420° C. to 500° C.

17. The spring according to claim 15, wherein the lattice constant is 2.881 Å to 2.890 Å.

18. The spring according to claim 17, wherein the nitriding treatment is performed at 420° C. to 500° C.

19. The spring according to claim 15, wherein an average grain size of spherical carbide formed in a steel wire after the nitriding treatment and tempering is 40 nm or less.

20. The spring according to claim 19, containing:
in terms of mass %,
0.50 to 0.75% of C;
1.50 to 2.50% of Si;
0.20 to 1.00% of Mn;
0.70 to 2.20% of Cr;
0.05 to 0.50% of V; and
a balance including Fe and inevitable impurities.

21. The spring according to claim 20,
wherein the spring further contains 0.02 to 1.00 wt % Co.

22. The spring according to claim 20, further containing, in terms of mass %, one or more selected from the group consisting of 0.1 to 1.0% of Ni, 0.05 to 0.50% of Mo, 0.05 to 0.15% of W, 0.05 to 0.15% of Nb, and 0.01 to 0.20% of Ti.

23. A spring produced by using the oil-tempered wire according to claim 1.

24. A method of producing an oil-tempered wire, the method comprising:
quenching a steel wire that is drawn; and
tempering the steel wire
wherein the quenching is performed after radiation heating at 850° C. to 950° C. for over 30 sec to 150 sec, and the tempering is performed at 400° C. to 600° C.

25. The method according to claim 24, wherein the tempering comprises:
a first tempering; and
a second tempering which is continuously performed after the first tempering at a temperature higher than that of the first tempering,
wherein the temperature of the first tempering process is 400° C. to 470° C., and the temperature of the second tempering process is 450° C. to 600° C.

26. A method of producing an oil-tempered wire, the method comprising:
quenching a steel wire that is drawn; and
tempering the steel wire,
wherein the quenching is performed after high frequency induction heating at 900° C. to 1050° C. for 1 sec to 10 sec,
wherein the tempering comprises:
a first tempering process; and
a second tempering which is continuously performed after the first tempering at a temperature higher than that of the first tempering,
wherein the temperature of the first tempering process is 400° C. to 470° C., and the temperature of the second tempering process is 450° C. to 600° C.

27. A method of producing an oil-tempered wire, the method comprising:
patenting a steel wire;
wire drawing the patented steel wire;
quenching the wire drawn steel wire; and
tempering the steel wire,
wherein the patenting comprises:
austenitizing the steel wire;
air cooling the steel wire at a cooling rate of 110° C./sec to 20° C./sec after the austenitizing; and
thereafter, conducting perlite transformation while keeping a predetermined temperature, and
wherein the quenching comprises heating the steel wire from a room temperature to 600° C. at a heating rate from 20° C./sec to less than 50° C./sec.

28. A method of producing an oil-tempered wire, the method comprising:
patenting a steel wire;
wire drawing the patented steel wire;
quenching the wire drawn steel wire; and
tempering the steel wire,
wherein the patenting comprises:
austenitizing the steel wire;
air cooling the steel wire at a cooling rate of 10° C./sec to 20° C./sec after the austenitizing; and
thereafter, conducting perlite transformation while keeping a predetermined temperature, and
wherein the quenching comprises heating the steel wire from 600° C. to a keeping temperature at a heating rate of 5° C./sec to 20° C./sec.

29. A method of producing an oil-tempered wire, the method comprising:
patenting a steel wire;
wire drawing the patented steel wire;
quenching the wire drawn steel wire; and
tempering the steel wire,
wherein the quenching comprises:
heating the steel wire from a room temperature to 600° C. at a heating rate from 20° C./sec to less than 50° C./sec; and
further heating the steel wire from 600° C. to a keeping temperature at a heating rate of 5° C./sec to 20° C./sec.
